(19) United States
(12) Patent Application Publication
(10) Pub. No.: US 2020/0295884 A1
(43) Pub. Date: Sep. 17, 2020

(54) A Network Node And A Terminal Device, And Methods Of Operating The Same

(71) Applicant: Telefonaktiebolaget LM Ericsson (publ), Stockholm (SE)

(72) Inventors: Andreas BERGSTRÖM, Linköping (SE); Håkan ANDERSSON, LINKÖPING (SE); Stefan PARKVALL, Stockholm (SE); Niclas WIBERG, LINKÖPING (SE); Qiang ZHANG, Stockholm (SE)

(21) Appl. No.: 15/932,344

(22) PCT Filed: Aug. 17, 2015
(86) PCT No.: PCT/EP2015/068862

§ 371 Date: Feb. 16, 2018

(51) Int. Cl. H04L 1/18

(52) U.S. Cl. CPC H04L 1/1816; H04L 1/189

(57) ABSTRACT

According to an aspect there is provided a method of operating a network node in a communication network, the method comprising sending a first uplink grant message to a terminal device, the first uplink grant message comprising a first value for a sequence number and comprising information for one or more subframes that are scheduled for uplink transmissions from the terminal device. According to another aspect, there is provided a method of operating a terminal device in a communication network, the method comprising receiving a first uplink grant message from a network node in the communication network, the first uplink grant message comprising a value for a sequence number and comprising information for one or more subframes that are scheduled for uplink transmissions from the terminal device.

### TECHNICAL FIELD

This disclosure relates to a network node and a terminal device for use in a communication network, and in particular relates to uplink grant messages that are used to schedule uplink transmissions from the terminal device to the network node.

### BACKGROUND

Uplink (UL) transmissions in Long Term Evolution (LTE) utilise so-called Hybrid Automatic Repeat-reQuest (HARQ) so that transmissions from a user equipment (UE) that are not properly received at the radio base station (denoted eNB or eNodeB in LTE) can be retransmitted. In a HARQ scheme with soft combining, a data packet that is received with errors that cannot be corrected using error correction techniques is stored in a buffer and combined with a subsequent retransmission of the data packet so that the data can be decoded. A HARQ scheme with soft combining can use incremental redundancy, which means that the retransmitted data packet is not identical to the original transmission of the data packet, and in particular the retransmission of the data packet can include a different set of redundant bits to the originally transmitted data packet. Each set of redundancy bits is denoted a Redundancy Version (RV).

Thus, each UL transmission is associated with a unique HARQ process, which on the UE-side contains all the different RVs of that transmission. On the eNB-side, the HARQ process contains the soft information received so far. When additional RVs belonging to that HARQ process are received by the eNB (i.e. following a retransmission by the UE) they are soft-combined with the already stored information in order to improve the possibility of correct decoding.

The uplink HARQ retransmissions in LTE are scheduled by the NW, which will send an uplink grant message to the scheduled UE on a Physical Downlink Control Channel (PDCCH) (or enhanced PDCCH (ePDCCH)). This UL grant includes an indication of which HARQ process the grant is associated with, which modulation and coding scheme (MCS) and RV the UE is to use, and a New Data Indicator (NDI) field, for the corresponding transmission.

The above HARQ scheduling procedure is illustrated in FIGS. 1 and 2. FIG. 1 illustrates the steps performed in an eNB and FIG. 2 illustrates the steps performed in a UE.

In step 101 of FIG. 1, the eNB prepares an uplink grant message for a specific HARQ process. The uplink grant message will comprise information for a subframe that the UE is to use to transmit the uplink data. In some cases this information will be explicit, i.e. the information will explicitly identify a subframe, whereas in other cases the timing of the uplink grant message will indicate the subframe. In step 103, it is determined whether the eNB needs to request retransmission of the last data packet received from the UE. If no retransmission is required, then the method moves to step 105 in which the eNB clears the soft buffer (the buffer that is used to store received data packets and their retransmissions so that they can be soft combined and correctly decoded). The eNB then toggles the New Data Indicator field compared to the NDI field in the previous UL grant message for that HARQ process to indicate that the UL grant is for the transmission of new data from the UE (step 107). The eNB then selects a new MCS for the UL grant (step 109) and sets a redundancy version indicator (RVI) field to 0 or some other default or initial value (step 111). The eNB then encodes the RVI into the MCS (where if the RVI>0 then the MCS is equal to 28+RVI) in step 112. Note that when RVI=0, such as is the case of a new transmission, this leaves MCS unchanged. The eNB then sends the uplink grant message including the NDI field, and the MCS (with the RVI encoded therein) (step 113).

If at step 103 the eNB requires a retransmission of the last data packet from the UE, the method passes to step 115 in which the eNB steps the RVI to the next RV. The eNB then sends the uplink grant message to the UE, with the uplink grant message including the adjusted RVI, an NDI field and the MCS. The NDI field indicated in the UL grant message will be the same as the previous UL grant message. The MCS may be the same as in the previous UL grant message or different. In 3GPP the RVI is encoded in the UL grant with the MCS. In particular, according to 3GPP 36.213 “Evolved Universal Terrestrial Radio Access (E-UTRA); Physical layer procedures”, v12.6.0, section 8.6.1, MCS values 0 . . . 28 are encoded with RVI value 0, MCS value 29 is encoded with RVI value 1, MCS value 30 is encoded with RVI value 2 and MCS value 31 is encoded with RVI value 3.

Referring now to FIG. 2, the UE receives an uplink grant message for a specific HARQ process (step 200). The uplink grant message will indicate a subframe in which the UE is to transmit uplink data (either explicitly or implicitly as noted above), along with an NDI field, the MCS the UE is to use and a RVI that indicates the RV the UE is to use for the transmission. The RVI will be encoded with the MCS, so in step 201 the UE extracts the current RVI from the signalled MCS value (where the RVI is the maximum of 0 and MCS-28). In step 202 the UE determines the actual MCS, i.e. if MCS>28, then the MCS from an earlier uplink grant message will be taken.

In step 203 the UE determines if the NDI field or a transport block (TB) size has changed compared to the last uplink grant message received from the eNB for the same HARQ process. If neither of the NDI field and TB size have changed then the eNB is requesting retransmission of the previous data packet, and the UE transmits the data packet/TB to the eNB using the current RVI in the UL grant message received in step 201 (step 205).

If either or both of the NDI field and TB size have changed then the eNB is requesting the transmission of new data from the UE, and the UE prepares a data packet/TB with new data using the actual MCS determined in step 202 (step 207). The UE then transmits the data packet/TB with the new data to the eNB using the current RVI signalled in the received UL grant message (step 205).

In a time division duplex (TDD) system, the UL and downlink (DL) transmissions occur on the same frequency band but at different time instances. A given subframe can only be one of UL or DL. In a static TDD system, there is a fixed pattern (TDD configuration) that specifies which subframes are designated for UL and DL, respectively.

In a semi-static TDD system, such as that defined in LTE Release 12, switching between TDD configurations can be done in a slow time frame, using higher-layer signalling. Typically, these switches can be performed every frame, i.e., 10 milliseconds (ms).

In a fully dynamic TDD system, however, there is no fixed pattern that specifies the UL/DL ratio. Instead, this is decided “on-the-fly” by the scheduler, per subframe, in the eNB depending on the momentary traffic pattern. Certain restrictions do apply, however. Some subframes will be fixed as DL subframes to allow transmission of, e.g., synchronisation signals, DL control information and channel state information-reference signals (CSI-RS). Other subframes will be fixed for UL transmission to allow for UL control information and random-access signalling.

The LTE downlink was designed so that one scheduling message schedules one data transmission in the uplink or one data reception in the downlink. Multi-subframe scheduling means that a scheduling message can schedule multiple subframes.

When the multi-subframe scheduling activation flag is enabled the UE shall assume that the scheduling message (downlink control message (DCI)) is valid for multiple subframes instead of a single subframe. The bitmap pattern will indicate the special subframes for which the UE shall assume that the received DCI message in that subframe is valid for N>1 subframes instead of only that subframe.

For example, if the flag is enabled and the bitmap over RRC is 0100010010 and N=2 it means that scheduling in subframe 2, 6 and 9 is also valid for subframes 3, 7, and 10. Alternatively, the flag could be present in the DCI message.

In fully dynamic TDD and in an UL-heavy scenario there may be a single DL subframe followed by n consecutive UL subframes, where n could be in the order of several tens. Some subframes may be skipped or excluded, for instance if they are reserved for other purposes. In this situation, all n UL subframes must be scheduled by the eNB and granted to a UE in this one DL subframe. This is another application of multi-subframe scheduling. The resource allocation granted to the UE is then applied to the n subframes given by the multi-subframe grant.

If a given subframe is used for DL there can also be a DL grant transmitted on the EPDCCH, which details the resource allocation of the Physical Downlink Shared Channel (PDSCH) transmission. A potential advantage of using multi-subframe scheduling on DL would be that fewer grant messages need to be transmitted and space can be saved on the EPDCCH.

In UL, however, the advantages of multi-subframe scheduling are more accentuated. When scheduling UL transmissions and multi-subframe scheduling cannot be used, a new UL grant has to be transmitted on a DL control channel, e.g., the EPDCCH. This requires a DL transmission using a DL subframe, which in an UL-heavy scenario may be very wasteful since this subframe cannot convey any UL data.

In scenarios where each UL grant schedules one and only one uplink subframe on the Physical Uplink Shared Channel, PUSCH (i.e., normal scheduling), the cost of including all HARQ feedback-related information (i.e., RV, MCS, NDI) for the granted UL HARQ process is manageable. However, in the case of multi-subframe scheduling as described above, to include all the above information for each granted HARQ process will render an excessively large UL grant message that consumes an unreasonably large portion of the downlink control channel ((e)PDCCH) resources.

### SUMMARY

This problem can be alleviated by using a so-called ‘UE-managed RV method’ which corresponds to the non-adaptive re-transmission procedure defined in Section 5.4.2.2 of 3GPP TS 36.321 “Evolved Universal Terrestrial Radio Access (E-UTRA); Medium Access Control (MAC) protocol specification”, whereby the RV used for PUSCH retransmissions for each HARQ process is not explicitly signalled by the network (eNB). It is instead managed by the UE which keeps track of the RV Index for each re-transmission and steps the RV index after each transmission. The RV index points to the next RV in a predefined sequence of RVs (e.g. 0,2,3,1). This procedure ensures that the UE and eNB have a common understanding of the RV to be used for the transmission of a given UL HARQ process.

The above UE-managed RV method can be used when a retransmission can use the same resources that were granted for the initial transmission. In such cases it can be sufficient for the eNodeB to send a simple NACK (negative acknowledgement) message to the UE, instructing it to send a retransmission where only the RV is different from the original transmission. In cases where it is required to assign different resources for the retransmission, an adaptive retransmission can instead be used and the eNodeB then sends a full UL grant to the UE. This is illustrated in FIGS. 3 and 4. FIG. 3 illustrates the steps performed in an eNB and FIG. 4 illustrates the steps performed in a UE.

In FIG. 3, steps 301, 303, 305, 307, 309, 311, 312 and 315 correspond to steps 101, 103, 105, 107, 109, 111, 112 and 115 in FIG. 1 respectively. After step 315 (the stepping of the RVI), the eNB determines if adaptive retransmission is required (step 317). If adaptive retransmission is required, then the method proceeds to step 312 and the RVI is encoded into the MCS. If adaptive retransmission is not required then the eNB sends a negative acknowledgement, NACK (step 319).

In FIG. 4, steps 401, 403 and 407 correspond to steps 200, 203 and 207 in FIG. 2 respectively,

If in step 403 it is determined that neither of the NDI field and TB size have changed then the eNB is requesting retransmission of the previous data packet, and the UE determines the RVI from the UL grant (i.e. RVI=MCS-28) in step 404. The UE then transmits the data packet/TB to the eNB using the RVI determined in step 404 (step 405).

If in step 403 it is determined that either or both of the NDI field and TB size have changed then the eNB is requesting the transmission of new data from the UE, and the UE sets a redundancy version indicator (RVI) field to 0 or some other default or initial value (step 406). The UE then prepares a data packet/TB with new data using the MCS signalled in the UL grant message received in step 401 (step 407). The UE then transmits the data packet/TB with the new data to the eNB using the RVI determined in step 406 (step 405).

If no uplink grant for a specific HARQ process is received, but a NACK is received (step 409), then the UE steps the RVI to the next RV (step 411) and transmits the data packet/TB to the eNB (step 405). This is the so-called UE-managed RV method.

The UE-managed RV method as discussed above indeed allows a more compact signalling of the HARQ-related information in an UL grant which, especially in the case of multi-subframe uplink scheduling, is essential to save downlink control channel resources.

The problem, however, is that there may be error cases in which there will be a discrepancy in the understanding between the eNB and UE in terms of which RV shall be used for the transmission of a given UL HARQ process. This could happen if the multi-subframe UL grant is not received by the UE, which from an eNB perspective is difficult to distinguish from the case when the UL grant was received by the UE, but the actual PUSCH transmission failed.

Even more severe problems may also arise whenever the set of HARQ processes changes (due to, e.g., a change in the dynamic TDD pattern) in conjunction with an event such as losing a multi-subframe UL grant message.

Thus improvements to the UE-managed RV method are required in order to address or mitigate the problems outlined above.

In a UE-managed RV method, in order to ensure that a UE and an eNB (and more generally the communication network) have a common understanding of the redundancy version (RV) to be used for the transmission of a given uplink HARQ process, the techniques described herein provide that the eNB includes an additional piece of information in an uplink grant message that is used by the UE to set the correct RV in the event that it has missed an uplink grant message from the eNB or the eNB is uncertain whether the UL grant message was received or not. This additional piece of information is referred to herein as a sequence number or Grant Sequence Number (GSN).

The techniques described herein provide that the compact signalling of the HARQ-related information in an UL grant in a UE-managed RV method is made more robust to error cases such as, e.g., when a multi-subframe UL grant is not received by the UE and/or when the set of HARQ process included in the multi-subframe grant changes.

According to a first aspect, there is provided a method of operating a network node in a communication network, the method comprising sending a first uplink grant message to a terminal device, the first uplink grant message comprising a first value for a sequence number and comprising information for one or more subframes that are scheduled for uplink transmissions from the terminal device.

According to a second aspect, there is provided a network node for use in a communication network, the network node being adapted to send a first uplink grant message to a terminal device, the first uplink grant message comprising a first value for a sequence number and comprising information for one or more subframes that are scheduled for uplink transmissions from the terminal device.

According to a third aspect, there is provided a computer program product comprising a computer readable medium having computer readable code embodied therein, the computer readable code being configured such that, on execution by a suitable computer or processor, the computer or processor is caused to perform the method described above.

According to a fourth aspect, there is provided a method of operating a terminal device in a communication network, the method comprising receiving a first uplink grant message from a network node in the communication network, the first uplink grant message comprising a value for a sequence number and comprising information for one or more subframes that are scheduled for uplink transmissions from the terminal device.

According to a fifth aspect, there is provided a terminal device for use in a communication network, the terminal device being adapted to receive a first uplink grant message from a network node in the communication network, the first uplink grant message comprising a value for a sequence number and comprising information for one or more subframes that are scheduled for uplink transmissions from the terminal device.

According to a sixth aspect, there is provided a computer program product comprising a computer readable medium having computer readable code embodied therein, the computer readable code being configured such that, on execution by a suitable computer or processor, the computer or processor is caused to perform the method described above.

According to a seventh aspect, there is provided a network node for use in a communication network, the network node comprising a processor and a memory, said memory comprising instructions executable by said processor whereby said network node is operative to send a first uplink grant message to a terminal device, the first uplink grant message comprising a first value for a sequence number and comprising information for one or more subframes that are scheduled for uplink transmissions from the terminal device.

According to an eighth aspect, there is provided a terminal device for use in a communication network, the terminal device comprising a processor and a memory, said memory comprising instructions executable by said processor whereby said terminal device is operative to receive a first uplink grant message from a network node in the communication network, the first uplink grant message comprising a value for a sequence number and comprising information for one or more subframes that are scheduled for uplink transmissions from the terminal device.

According to a ninth aspect, there is provided a network node for use in a communication network, the network node comprising a first module configured to send a first uplink grant message to a terminal device, the first uplink grant message comprising a first value for a sequence number and comprising information for one or more subframes that are scheduled for uplink transmissions from the terminal device.

According to a tenth aspect, there is provided a terminal device for use in a communication network, the terminal device comprising a first module configured to receive a first uplink grant message from a network node in the communication network, the first uplink grant message comprising a value for a sequence number and comprising information for one or more subframes that are scheduled for uplink transmissions from the terminal device.

### BRIEF DESCRIPTION OF THE DRAWINGS

Features, objects and advantages of the presently disclosed techniques will become apparent to those skilled in the art by reading the following detailed description where references will be made to the appended figures in which:

FIG. 1 illustrates a method of operating an eNB in a conventional HARQ scheduling procedure;

FIG. 2 illustrates a method of operating a UE in a conventional HARQ scheduling procedure;

FIG. 3 illustrates a method of operating an eNB that dynamically selects between signalling an RVI and using a UE-managed RV method;

FIG. 4 illustrates a method of operating a UE that either receives an RVI in an UL grant or uses a UE-managed RV method;

FIG. 5 illustrates an exemplary LTE network in which the techniques described herein can be implemented;

FIG. 6 is a block diagram of a terminal device according to an embodiment;

FIG. 7 is a block diagram of a network node according to an embodiment;

FIG. 8 illustrates a method of operating an eNB according to a first exemplary embodiment of the techniques described herein;

FIG. 9 illustrates a method of operating a UE according to a first exemplary embodiment of the techniques described herein;

FIG. 10 illustrates a method of operating an eNB according to a second exemplary embodiment of the techniques described herein;

FIG. 11 illustrates a method of operating a UE according to a second exemplary embodiment of the techniques described herein;

FIG. 12 illustrates a method of operating an eNB according to a third exemplary embodiment of the techniques described herein;

FIG. 13 illustrates a method of operating a UE according to a third exemplary embodiment of the techniques described herein;

FIG. 14 is a flow chart illustrating a general method of operating a network node according to the techniques described herein;

FIG. 15 is a flow chart illustrating a general method of operating a terminal device according to the techniques described herein;

FIG. 16 illustrates a method of operating an eNB according to a fourth exemplary embodiment of the techniques described herein; and

FIG. 17 illustrates a method of operating a UE according to a fourth exemplary embodiment of the techniques described herein.

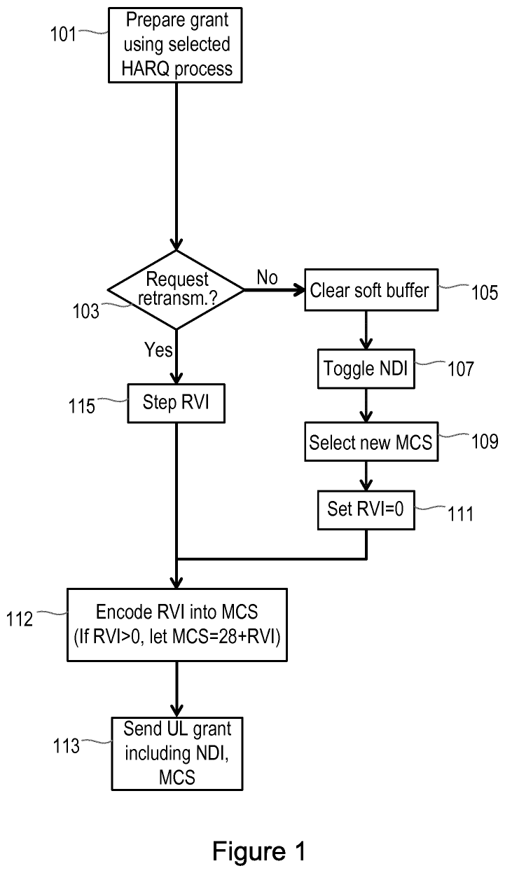

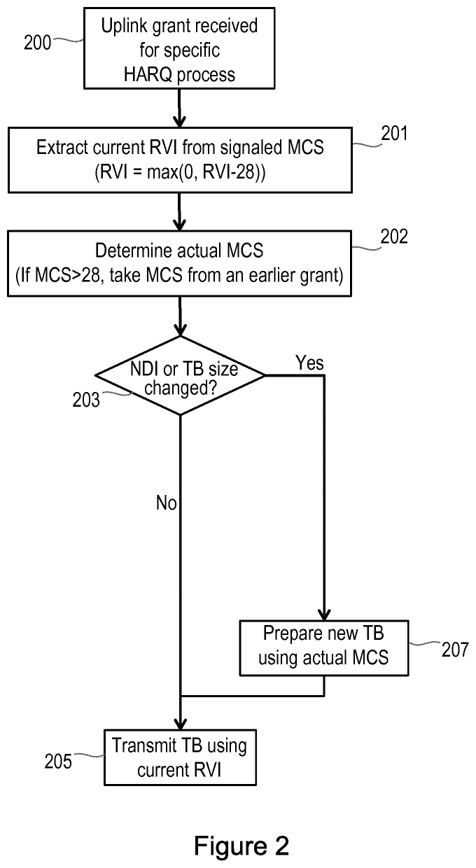

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing units, one or more processing modules or one or more controllers, and the terms computer, processor, processing unit, processing module and controller may be employed interchangeably. When provided by a computer, processor, processing unit, processing module or controller, the functions may be provided by a single dedicated computer, processor, processing unit, processing module or controller, by a single shared computer, processor, processing unit, processing module or controller, or by a plurality of individual computers, processors, processing units, processing modules or controllers, some of which may be shared or distributed. Moreover, these terms also refer to other hardware capable of performing such functions and/or executing software, such as the example hardware recited above.

Although in the description below the term user equipment (UE) is used, it should be understood by the skilled in the art that “UE” is a non-limiting term comprising any mobile or wireless device or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE”, the terms “mobile device” and “terminal device” may be used interchangeably in the following description, and it will be appreciated that such a device does not necessarily have to be ‘mobile’ in the sense that it is carried by a user. Instead, the terms “mobile device” and “terminal device” encompass any device that is capable of communicating with communication networks that operate according to one or more mobile communication standards, such as the Global System for Mobile communications, GSM, Universal Mobile Telecommunications System, UMTS, Long-Term Evolution, LTE, etc, or future ‘5G’ communication standards.

A cell is associated with a base station, where a base station comprises in a general sense any network node transmitting radio signals in the downlink and/or receiving radio signals in the uplink. Some example base stations, or terms used for describing base stations, are eNodeB, eNB, NodeB, macro/micro/pico/femto radio base station, home eNodeB (also known as femto base station), relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band modules for different RATs.

It should be noted that use of the term “network node” as used herein can refer to a base station, such as an eNodeB, a network node in the radio access network (RAN) responsible for resource management, such as a radio network controller (RNC), or, in some cases, a core network node, such as a mobility management entity (MME).

Unless otherwise indicated herein, the signalling described is either via direct links or logical links (e.g. via higher layer protocols and/or via one or more network nodes).

Although the techniques described herein are presented in terms of a UE and a communication network operating according to the LTE standards, it will be appreciated that the techniques can be applied to any current or future communication standard or protocol that makes use of a UE-managed redundancy version method for a hybrid automatic repeat request (HARQ) process.

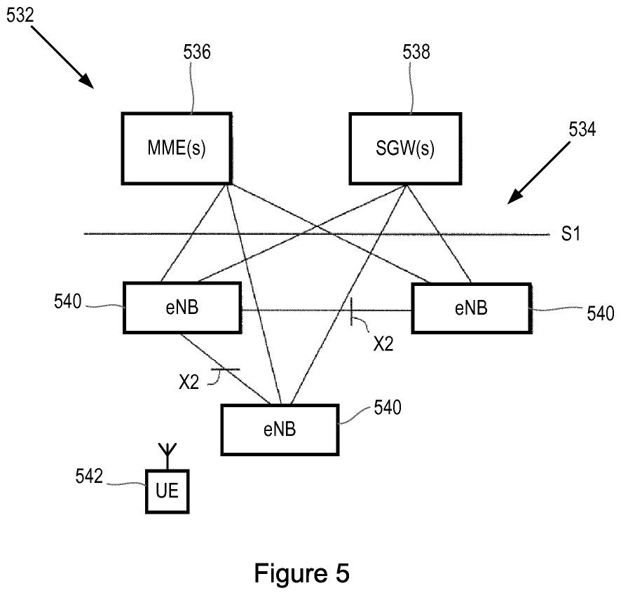

FIG. 5 shows an example diagram of an evolved UMTS Terrestrial Radio Access Network (E-UTRAN) architecture as part of an LTE-based communications system 532 to which the techniques described herein can be applied. Nodes in a core network 534 part of the system 532 include one or more Mobility Management Entities (MMEs) 536, a key control node for the LTE access network, and one or more Serving Gateways (SGWs) 538 which route and forward user data packets while acting as a mobility anchor. They communicate with base stations 540 referred to in LTE as eNBs, over an interface, for example an S1 interface. The eNBs 540 can include the same or different categories of eNBs, e.g. macro eNBs, and/or micro/pico/femto eNBs. The eNBs 540 communicate with each other over an inter-node interface, for example an X2 interface. The S1 interface and X2 interface are defined in the LTE standard. A UE 542 is shown, and a UE 542 can receive downlink data from and send uplink data to one of the base stations 540, with that base station 540 being referred to as the serving base station of the UE 542.

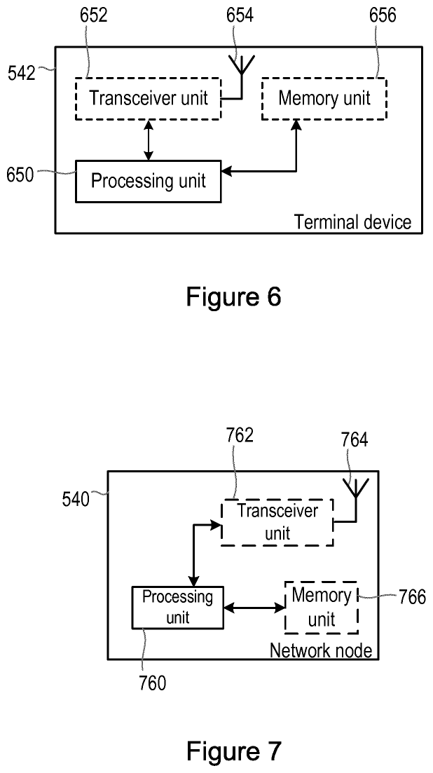

FIG. 6 shows a terminal device (UE) 542 that can be adapted or configured to operate according to one or more of the non-limiting example embodiments described. The UE 542 comprises a processor or processing unit 650 that controls the operation of the UE 542. The processing unit 650 can be connected to a transceiver unit 652 (which comprises a receiver and a transmitter) with associated antenna(s) 654 which are used to transmit signals to and receive signals from a base station 640 in the network 32 (e.g. an eNB 540). The UE 542 can also comprise a memory or memory unit 656 that is connected to the processing unit 650 and that contains instructions or computer code executable by the processing unit 650 and other information or data required for the operation of the UE 542.

FIG. 7 shows a network node (for example a cellular network base station such as an eNodeB) that can be adapted or configured to operate according to the example embodiments described. The network node 540 comprises a processor or processing unit 760 that controls the operation of the network node 540. The processing unit 760 can be connected to a transceiver unit 762 (which comprises a receiver and a transmitter) with associated antenna(s) 764 which are used to transmit signals to, and receive signals from, UEs 542 in the network 532. The network node 540 can also comprise a memory or memory unit 766 that is connected to the processing unit 760 and that contains instructions or computer code executable by the processing unit 760 and other information or data required for the operation of the network node 540. Although not shown in FIG. 7, the network node 540 can also include components and/or circuitry 768 for allowing the network node 540 to exchange information with another network node 540 (for example via an X2 and/or S1 interface). It will be appreciated that base stations for use in other types of network (e.g. UTRAN or Wideband Code Division Multiple Access (WCDMA) radio access network (RAN)) will include similar components to those shown in FIG. 7 and appropriate interface circuitry for enabling communications with the other network nodes in those types of networks (e.g. other base stations and/or nodes in the core network).

It will be appreciated that only the components of the UE 542 and network node 540 required to explain the embodiments presented herein are illustrated in FIGS. 6 and 7.

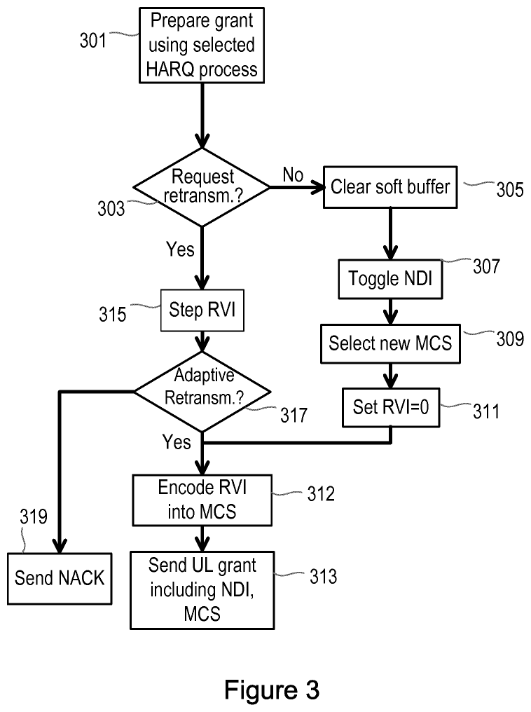

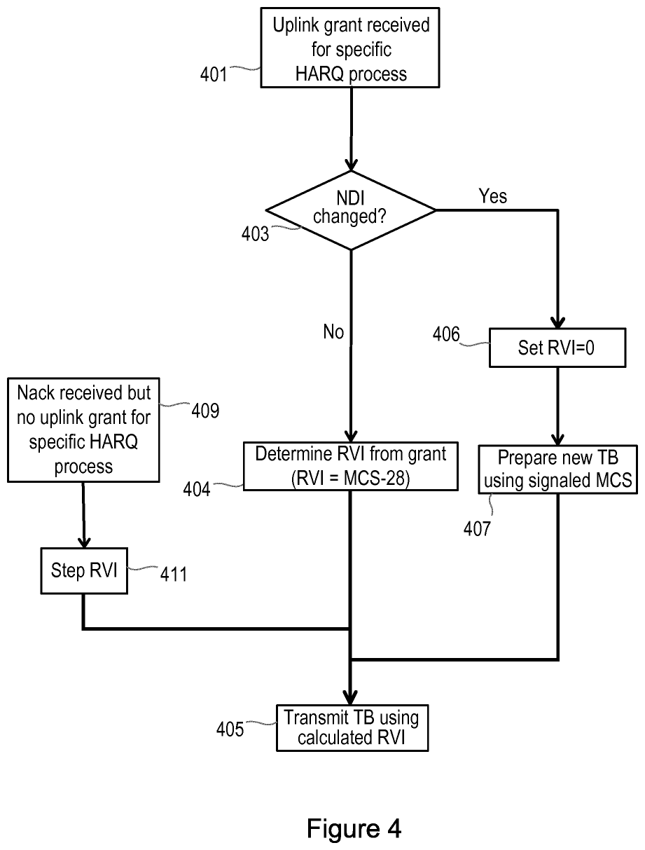

As noted above, the UE-managed redundancy version (RV) method shown in FIGS. 3 and 4 allows a more compact signalling of the HARQ-related information in an UL grant which, especially in the case of multi-subframe uplink scheduling, is essential to save downlink control channel resources. However, it is important to avoid discrepancies in the understanding between the eNB and UE in terms of which RV shall be used for the transmission of a given UL HARQ process, particularly where a multi-subframe UL grant is not received by the UE or an actual PUSCH transmission from the UE failed.

Thus, according to the techniques described herein, in order to ensure that a UE 542 and an eNB 540 (and more generally the communication network) have a common understanding of the redundancy version (RV) to be used for the transmission of a given uplink HARQ process, the eNB 540 includes an additional piece of information in an uplink grant message that is used by the UE 542 to set the correct RV in the event that the UE has missed an uplink grant message from the eNB 540, or in the event that the eNodeB has incorrectly assumed that the UE has missed an uplink grant message.

This additional piece of information is referred to herein as a sequence number or Grant Sequence Number (GSN). A value for the GSN is included in each uplink grant message, regardless of whether the uplink grant messages relate to the same HARQ process(es) or not.

Thus, in some embodiments a conventional UL grant message structure is modified to include a GSN, which can be represented by one or more bits in a field in the UL grant. Generally, if the eNB 540 (or other node in the communication network) determines that the UE 542 has failed to receive the preceding UL grant message (for example according to the exemplary techniques described below), the eNB 540 shall include the same value for the GSN that was included in the preceding UL grant message. If, on the other hand, the eNB 540 (or other node in the communication network) estimates or determines that the UE 540 did successfully receive the previous UL grant message, then the eNB 540 can increase the value of the GSN to the next value for use in the next UL grant message. In some embodiments, when the GSN reaches its highest possible value, the next increment of the value of the GSN will result in the value wrapping-around to the lowest possible GSN value.

In some embodiments, the GSN can be represented by a single bit, and therefore the increment of its value will correspond to a simple toggling, e.g. between zero and one. In this embodiment, the eNB 540 will toggle the value of the GSN from the previous UL grant to indicate that the eNB 540 considers the UE 542 to have successfully received the previous UL grant message.

It should be noted that consecutive UL grant messages sent to a UE 542 typically specify different HARQ processes, so the last UL grant message sent to the UE for a specific HARQ process or group of HARQ processes is not necessarily the last UL grant message that was sent to the UE. For example, one UL grant may include HARQ processes 0-15, while the next UL grant may include HARQ processes 16-31.

Thus, in some embodiments, as described in more detail below, when the UE 542 receives a multi-subframe UL grant that indicates a group of HARQ processes, the UE 542 can determine whether that group of HARQ processes was treated as a group in a previous UL grant message. In other words, for each HARQ process included in the group of HARQ processes in the received UL grant, the UE 542 determines whether the most recent (previous) UL grant for that HARQ process included all of the other HARQ processes in the group in the current UL grant. If so, it can be said that the current UL grant keeps its group intact, and there is a previous UL grant for the group.

In some embodiments the GSN may thus be applied per group of HARQ processes. If the current grant keeps its group intact, then the UE 542 can compare the GSN in the current UL grant and the previous UL grant (for that same group of HARQ processes) to determine if the GSN has changed.

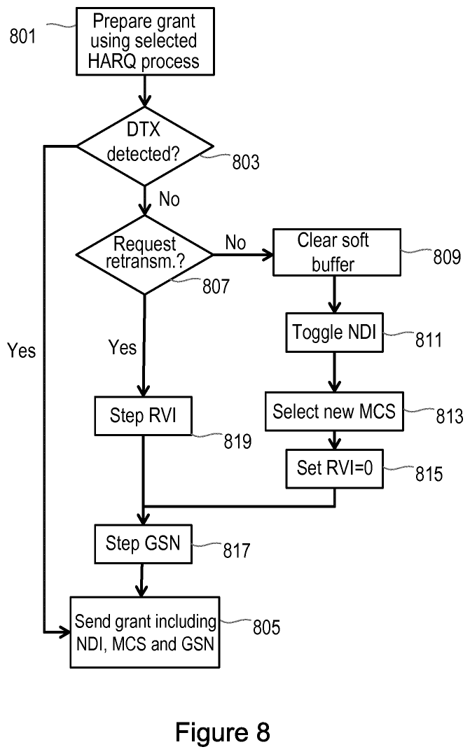

The flow chart in FIG. 8 illustrates a method of operating an eNB 540 according to a first exemplary embodiment of the techniques described herein in which the UE-managed RV method is modified to include the use of a GSN as described above.

In step 801 of FIG. 8, the eNB 540 prepares an uplink grant message for a specific HARQ process (or group of HARQ processes). The uplink grant message will comprise information for one subframe or multiple subframes (in the case of multi-subframe scheduling) that the UE 542 is to use to transmit uplink data. In some cases this information will be explicit, i.e. the information will explicitly identify one subframe or multiple subframes, whereas in other cases the timing of the uplink grant message will indicate the subframe(s). In a multi-subframe grant, some fields may have one instance per subframe. For example, there may be one NDI field per subframe. Further, in some embodiments the grant may also include more than one transmission per subframe, for instance two transmissions per subframe (e.g. spatial multiplexing). In such embodiments, some fields may have instances corresponding to the different transmissions. For instance, there may be one MCS field per transmission. Moreover, some fields may have instances per combination of subframe and transmission. For instance, there may be one NDI field per combination of subframe and transmission. Whenever a specific field is mentioned in the description herein, it should be noted that it might refer to multiple fields, e.g. one per subframe or one per subframe and transmission.

The eNB 540 then determines whether the UE 542 may have failed to receive the last UL grant message for that specific HARQ process (or group of processes) that was sent by the eNB 540 to the UE 542 (step 803). The eNB generally will not know for certain that the last UL grant message was not received. The eNB is configured to make a determination, e.g. based on the information, measurements or lack of information received, on whether the UE did not receive the transmitted UL grant message. Thus, the eNB makes a determination (yes/no) on the failure of the UL grant message to be received by the UE, even if that determination is not made on certain evidence. References to determining whether the UE 542 may have failed to receive the last UL grant message may alternatively be replaced by references to determining that the UE 542 has failed to receive the last UL grant message.

There are a number of different ways in which the eNB 542 can determine whether the UE 542 may have failed to receive the last UL grant message.

In one embodiment, the eNB 540 may determine that the UE 542 has failed to receive a previously sent UL grant if the eNB 540 fails to detect any uplink transmissions by the UE 542 in any of the subframes scheduled by said UL grant message. This is referred to as discontinuous transmission (DTX)-detection by the network/eNB.

In another embodiment, when the UL grant message schedules multiple subframes, then the DTX detection by the network (i.e. detection of whether the UE 542 may have failed to receive the UL grant message) is based on whether any of the granted uplink transmissions have been correctly received or not. This can be determined by checking the cyclic redundancy checks (CRC) of the decoded transport blocks. If any of the transmissions is correctly received, the eNB can determine that the UL grant message was received. Thus, if the CRC checksum calculation fails for all transport blocks corresponding to a grant message, then the eNB 540 can determine that the UE 542 may have failed to receive the UL grant message, whereas if the checksum calculation is passed for at least one of the transport blocks, then the eNB 540 can determine that the UE 542 may have received the UL grant message.

The above embodiment is not considered to provide a good approach for determining if the UE 542 has failed to receive an UL grant message for UL grants that schedule a single subframe. Instead, in this case, the amount of signal energy received by the eNB 540 can be used for DTX detection (i.e. determining whether the UE 542 may have failed to receive the UL grant message) instead. The signal energy can be estimated on reference signals that are included in the uplink transmission and that are used for channel estimation.

In further embodiments, a combination of a CRC checksum calculation and analysis of the received signal energy are used to detect whether the UE 542 may have failed to receive an UL grant message. For instance, the uplink grant may be determined to have been received by the UE 542 if either at least one of the uplink transmissions is correctly received by the eNB 540 (as determined by, for example, checking their CRCs), or if the energy received in one or several of the transmissions is above a threshold.

If it is determined in step 803 that the UE 542 may not have received the previous UL grant message for the HARQ process or group of HARQ processes, then the eNB 540 sends an uplink grant message to the UE 542 (step 805). This uplink grant message is effectively a retransmission of the UL grant message that the UE 542 is deemed to have failed to receive, so the uplink grant message includes the same GSN value. The same value for the NDI field is also included. The UL grant message also indicates an MCS, which may be the same as or different to the MCS indicated in the previous UL grant. The inclusion in the uplink grant message of the same GSN value provides an indication to the UE that the uplink grant message is a repeated uplink grant message.

If it is determined in step 803 that the UE 542 has received the previous UL grant (i.e. DTX is not detected) for the HARQ process or group of HARQ processes, then the method passes to step 807, in which it is determined whether the eNB 540 needs to request retransmission of the last data packet received from the UE 542. Retransmission will be required if the eNB 540 was not able to successfully receive and decode the previous data packet from the UE 542. If no retransmission is required, then the method moves to step 809 in which the eNB 540 clears a soft buffer (the buffer that is used to store received data packets and their retransmissions so that they can be soft combined and correctly decoded). In some embodiment this soft buffer can be implemented in memory unit 766.

The eNB 540 then toggles (i.e. changes) the New Data Indicator field compared to the NDI field in the previous UL grant message for that HARQ process to indicate that the UL grant is for the transmission of new data from the UE (step 811). The eNB 540 then selects a new MCS for the UL grant (step 813) and sets a redundancy version indicator (RVI) field to 0 or some other default or initial value (step 815) for that HARQ process.

The eNB 540 then steps or increments the GSN to the next GSN value (step 817). That is, the eNB 540 increases the GSN compared to the GSN included in the previous UL grant message. As noted above, if the GSN was previously at the highest possible value, stepping the GSN results in the GSN value wrapping around to the lowest possible value.

The eNB 540 then sends the uplink grant message including the toggled NDI field, the new MCS and the stepped GSN value (step 805).

If at step 807 the eNB 540 requires a retransmission of the last data packet from the UE, the method passes to step 819 in which the eNB 540 steps the RVI to the next RV. The eNB 540 then steps or increments the GSN to the next GSN value (step 817). Finally, the eNB 540 then sends the uplink grant message to the UE, with the uplink grant message including an NDI field, the MCS and the incremented GSN value (step 805). The NDI field indicated in the UL grant message will be the same as the previous UL grant message for that HARQ process. The MCS may be the same as indicated in the previous UL grant message or different.

Steps 807 onwards in FIG. 8 can be performed for each HARQ process in a group of HARQ processes identified in the UL grant. That is, for each HARQ process it is determined whether retransmission should be requested (step 807), the RVI is set to the correct value (step 815 or 819) whereas in step 817 the GSN is increased per UL grant message. If the GSN is applied per HARQ process or group of HARQ processes then the GSN increases compared to the GSN included in the previous UL grant message for that HARQ process or group of HARQ processes (step 817).

Regarding the operations of the UE 542, when the UE 542 receives an uplink grant message for a HARQ process or group of HARQ processes, it compares the GSN value contained therein to the GSN value in the last received uplink grant message. If the GSN is applied per HARQ process or group of HARQ processes then the GSN is compared to the GSN value for that HARQ process or that group of HARQ processes. If the GSN values are the same (which means that the eNB 540 considers that the UE 542 may have failed to receive the previous UL grant), the UE will perform (re-)transmissions for all HARQ processes indicated by the received UL grant using the same RVI that was previously (intended to be) used for each of those HARQ processes. If, on the other hand, the GSN values are different, then the UE 542 shall instead follow the UE-managed RV method as shown in FIG. 4 for the given HARQ process(es).

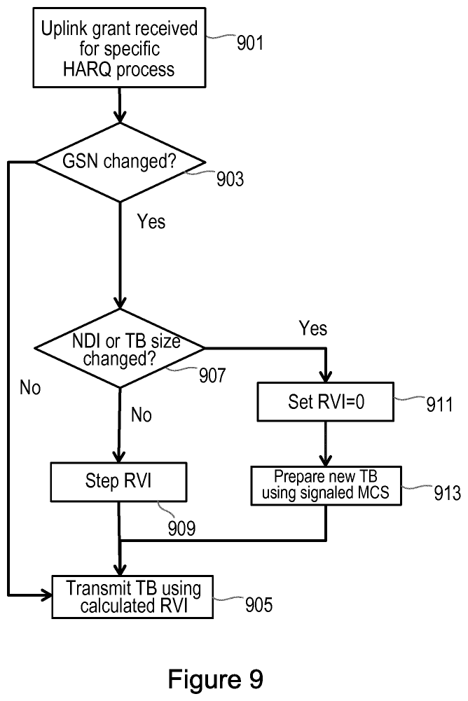

The flow chart in FIG. 9 illustrates a method of operating a UE 542 according to a first exemplary embodiment of the techniques described herein in which the UE-managed RV method is modified to include the use of a GSN as described above.

In step 901, the UE 542 receives an uplink grant message for a specific HARQ process or group of HARQ processes. The uplink grant message will indicate one or more subframes in which the UE 542 is to transmit uplink data (either explicitly or implicitly as noted above), along with an NDI field, the MCS the UE is to use and a value for the grant sequence number (GSN).

As noted above consecutive UL grant messages sent to a UE 542 typically specify different HARQ processes, so the last received UL grant message for the specific HARQ process or group of HARQ processes is not necessarily the last UL grant message the UE received. For example, one UL grant may include HARQ processes 0-15, while the next UL grant may include HARQ processes 16-31.

Although not shown in FIG. 9, when the UE 542 receives a multi-subframe UL grant that indicates a group of HARQ processes, the UE 542 can determine whether that group of HARQ processes was treated as a group in a previous UL grant message. In other words, for each HARQ process included in the group of HARQ processes in the UL grant received in step 901, the UE 542 determines whether the most recent (previous) UL grant for that HARQ process included all of the other HARQ processes in the group in the current UL grant. If so, it can be said that the current UL grant keeps its group intact, and there is a previous UL grant for the group.

If the current grant keeps its group intact, then the UE 542 can compare the GSN in the current UL grant (received in step 901) and the previous UL grant (for that same group of HARQ processes).

Thus, in step 903 the UE compares the value for the GSN in the received UL grant message to the value for the GSN in the last received UL grant message, e.g. for the specific HARQ process or group of HARQ processes.

If at step 903 it is determined that the value of the GSN has not changed (i.e. the values of the GSNs in the two UL grants are the same), then the UL grant received in step 901 is considered to be a repeated UL grant, and the method moves to step 905 in which the UE 542 retransmits the last transport block (TB)/data packet to the eNB 540 using the same RV that was used for the previous transmission of the data packet, using the MCS indicated in the UL grant received in step 901.

If in step 903 it is determined that the values of the GSNs in the UL grant messages are different, then the method passes to step 907 in which the UE 542 determines if the NDI field or a transport block (TB) size has changed compared to the last uplink grant message received from the eNB 540. The values of the GSNs will be different when either the UE 542 has missed an UL grant message and the eNB 540 resends it according to steps 803 and 805 in FIG. 8, or the eNB 540 considers that the UE did receive the previous UL grant and sends a new UL grant to the UE 542.

In step 907, if neither of the NDI field and TB size have changed then the eNB 540 is requesting retransmission of the previous data packet according to the HARQ process, and the UE 540 steps the RVI to the next RV in step 909. The UE 542 then transmits the data packet/TB to the eNB 540 using the RVI determined in step 909 (step 905).

If either or both of the NDI field and TB size have changed then the eNB 540 is requesting the transmission of new data from the UE, and the UE 542 sets a redundancy version indicator (RVI) field to 0 or some other default or initial value (step 911). The UE 542 then prepares a data packet/TB with new data using the MCS signalled in the UL grant message received in step 901 (step 913). The UE 542 then transmits the data packet/TB with the new data to the eNB using the RVI determined in step 911 (step 905).

Where the UL grant relates to a group of HARQ processes, the transmission of a data packet/TB in step 905 is performed for each HARQ process in the group. Steps 907-913 are also performed for each HARQ process in the group.

It will be appreciated that in some cases it is possible that the eNB may not detect, or may not immediately detect, that a UE has missed an uplink grant message, and the eNB will continue stepping the sequence number in each UL grant for that HARQ process/group of HARQ processes. It is therefore possible that when the UE determines whether the GSN has changed in step 903, the GSN may have changed by more than one value (e.g. the previous GSN may have been 2 and the current GSN may be 4, which means that the UE has missed the UL grant with GSN value 3).

Therefore, in some embodiments (not shown in FIG. 9), the method can be modified such that the UE determines if the GSN has changed by more than a single value (i.e. more than a single increment), and if so, the UE can either ignore the current UL grant and wait for the eNB to correct the situation (e.g. by resending the originally missed UL grant), or process the current UL grant (since it could be that the missed UL grant did not contain any of the same HARQ processes as the subsequent one and as such the UE will correctly determine the RVI).

In some further embodiments, a second additional piece of information can be included in an uplink grant message to identify a group of uplink grant messages that the uplink grant message belongs to. This second additional piece of information is referred to herein as a Grant Sequence Number Group (GSNG). This GSNG can be used to allow for the case where the set of HARQ processes to be included in the UL grant message changes due to, for example, changes in the dynamic TDD pattern. Thus, in some embodiments the UL grant message structure described above is further modified to include a GSNG, which can be represented by one or more bits in a field in the UL grant.

If the GSNG is present in an UL grant, this field indicates to the UE 542 the group of previous UL grants that the current UL grant is to be compared with. That is, as noted above, UL grant messages can relate to different groups of HARQ processes (where there may be some or no overlap between the HARQ processes in each group), and the GSNG can identify a particular group of HARQ processes. The network/eNB will only increase the GSN within each such group (i.e. each GSNG value) and the UE shall consequently only make comparisons between the current and previous GSN value if both involved UL grants contain the same GSNG value.

In some embodiments, the eNB 540 sets the value of the GSNG in an UL grant every time the HARQ processes granted in the UL grant have changed compared to the last transmission of the UL grant. If the HARQ process IDs in the UL grant remain the same, then the eNB 540 will not change the GSNG value from the last transmission of the UL grant.

In some other embodiments, the value of the GSNG can be set to one specific value whenever a given set of HARQ processes is granted in the UL grant. So, whenever this set of HARQ processes is granted, the exact same GSNG value will be used. For other sets of HARQ processes (which could be overlapping), then other GSNG values will be used.

In some embodiments, the GSNG can be represented by a single bit in the UL grant. In this case, the increment of the value of the GSNG will correspond to a simple toggling between zero and one. When applied to the embodiment above, this will limit the number of possible groups to two.

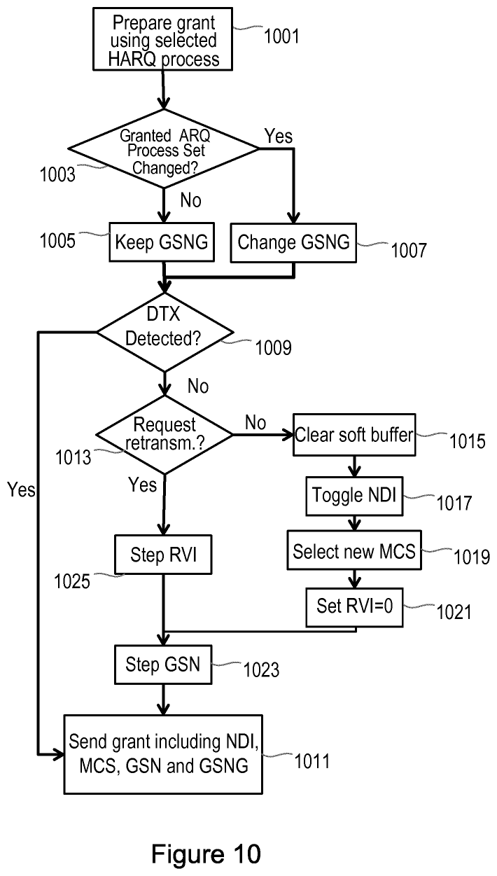

The flow chart in FIG. 10 illustrates a method of operating an eNB 540 according to a second exemplary embodiment of the techniques described herein in which the UE-managed RV method is modified to include the use of GSN and GSNG values as described above. The method in FIG. 10 is similar to that shown in FIG. 8, with additional steps relating to determining the value of the GSNG to include in the UL grant.

Thus, in step 1001 of FIG. 10, the eNB 540 prepares an uplink grant message for a specific HARQ process. The uplink grant message will indicate one subframe or multiple subframes (in the case of multi-subframe scheduling) that the UE 542 is to use to transmit uplink data.

In step 1003, the eNB 540 determines whether the granted HARQ process set has changed. For example, a first UL grant can schedule HARQ processes 0-7 (with GSNG value=0), and a second UL grant can schedule HARQ processes 8-15 (with GSNG value=1).

If it is determined that the granted ARQ process set has not changed, then the GSNG value is maintained at the current value (i.e. the value that was contained in the last UL grant message sent to the UE 542)—step 1005. However, if it is determined that the granted HARQ process set has changed, then the GSNG value is changed (step 1007) compared to the value that was contained in the last UL grant sent to the UE 542 (e.g. the GSNG value can be incremented to the next value or toggled to the alternative value in the case of a one-bit GSNG value).

After step 1005 or 1007, the method continues with steps 1009-1025 in FIG. 10. These steps respectively correspond to steps 803-819 in FIG. 8, with the only difference being that the eNB 540 includes the value of the GSNG determined in step 1005 or step 1007 (as appropriate) in the UL grant that is sent to the UE 542 in step 1011.

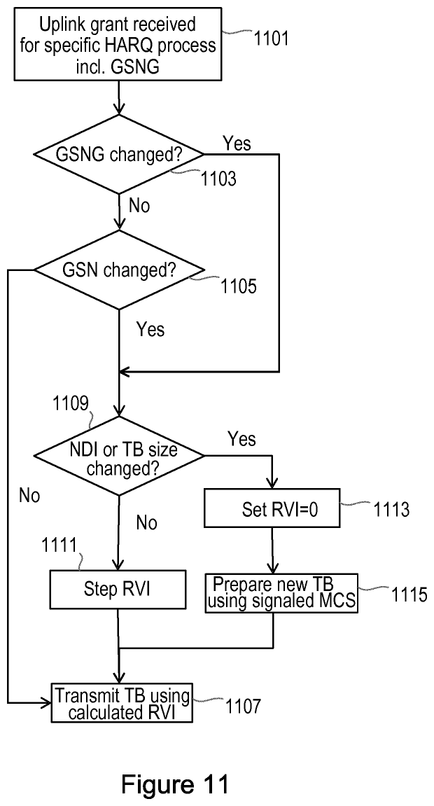

The flow chart in FIG. 11 illustrates a method of operating a UE 542 according to a second exemplary embodiment of the techniques described herein in which the UE-managed RV method is modified to include the use of GSN and GSNG values as described above. The method in FIG. 11 is similar to that shown in FIG. 9, with additional steps relating to the handling of the value of the GSNG included in the UL grant.

In step 1101, the UE 542 receives an uplink grant message for a specific HARQ process. The uplink grant message will indicate one or more subframes in which the UE 542 is to transmit uplink data, along with an NDI field, the MCS the UE is to use, a value for the grant sequence number (GSN) and a value for the grant sequence number group (GSNG).

In step 1103 the UE 542 compares the value for the GSNG in the received UL grant message to the value for the GSNG in the last received UL grant message to determine if the received UL grant belongs to the same group as the last received UL grant message.

If the GSNG value in the received UL grant message is the same as the value for the GSNG in the last received UL grant message (i.e. the UL grant messages belong to the same group), then the UE 542 proceeds with a comparison of the GSN values in the UL grant messages in step 1105.

If at step 1103 the GSNG value in the received UL grant message is not the same as the value for the GSNG in the last received UL grant message (i.e. the UL grant messages do not belong to the same group), then the UE 542 proceeds straight to step 1109.

Step 1105, and the subsequent steps 1107-1115 are performed in the same way as steps 903-913 in FIG. 9.

In some embodiments, the network node can keep track of a value for the GSNG without having to explicitly signal the GSNG in uplink grant messages. That is, the network node can keep track of whether the granted HARQ processes in the UL grant were granted together as a group the last time (in order to set the other fields in the UL grant message accordingly). Thus, in this case, the terminal device will not receive a GSNG value and instead the terminal device will keep track of whether the granted HARQ processes in the UL grant were granted together as a group the last time. Thus, the wireless device determines a group for the sequence number using information received in the uplink grant message, e.g. based on a group of granted HARQ processes, without receiving an explicit indication of the GSNG.

In alternative embodiments for handling groups of HARQ processes included in an UL grant, in order to further ensure that a UE and an eNB have a common understanding of the RV to be used for a given HARQ process, the eNB includes another piece of information in an uplink grant message in addition to the sequence number (GSN) that is used by the eNB to indicate whether the UE is to autonomously step the RVI for the given HARQ process or acquire the RVI either implicitly (e.g. by setting it to a default value) or explicitly (for example if it is included in the UL grant message itself). This additional piece of information is referred to herein as a Differential RVI Indicator (DRI).

The DRI is also referred to herein as a redundancy version status (e.g. okay/true and not okay/false) and an indicator for redundancy version information. The RV status can be used to indicate whether the UE is to set the RV to a predetermined value or the UE is to autonomously manage the selection of the RV for a given hybrid automatic repeat request, HARQ, process.

In some examples, the redundancy version status may be considered as an indicator of redundancy version information. The indicator of redundancy version information may indicate whether or not the normal UE managed process (i.e. without explicit signalling of redundancy version) is determined by the network to be operating properly. In some examples, the indicator of redundancy version information indicates, or only indicates, a predetermined (e.g. default) value of RV should be used. In some examples, the indicator of redundancy version information indicates, or only indicates, a value of the RV to be used by the wireless terminal. In some examples, the term indicator of redundancy version information may be used instead of RV status.

Thus, in some embodiments the UL grant message structure is modified to include a GSN and a DRI. Each of the GSN and DRI can be represented by one or more bits in respective fields in the UL grant. In some examples, the DRI is represented by a single bit. Thus, the DRI is explicitly signalled in an UL grant message, for example using one or more bits in a field in the UL grant message. Alternatively, the DRI can be signalled together with other pieces of information. As another alternative, the DRI can be explicitly signalled to indicate one of the statuses (i.e. one of: the UE is to autonomously step the RVI, or acquire the RVI either implicitly or explicitly) and omitted to indicate the other status.

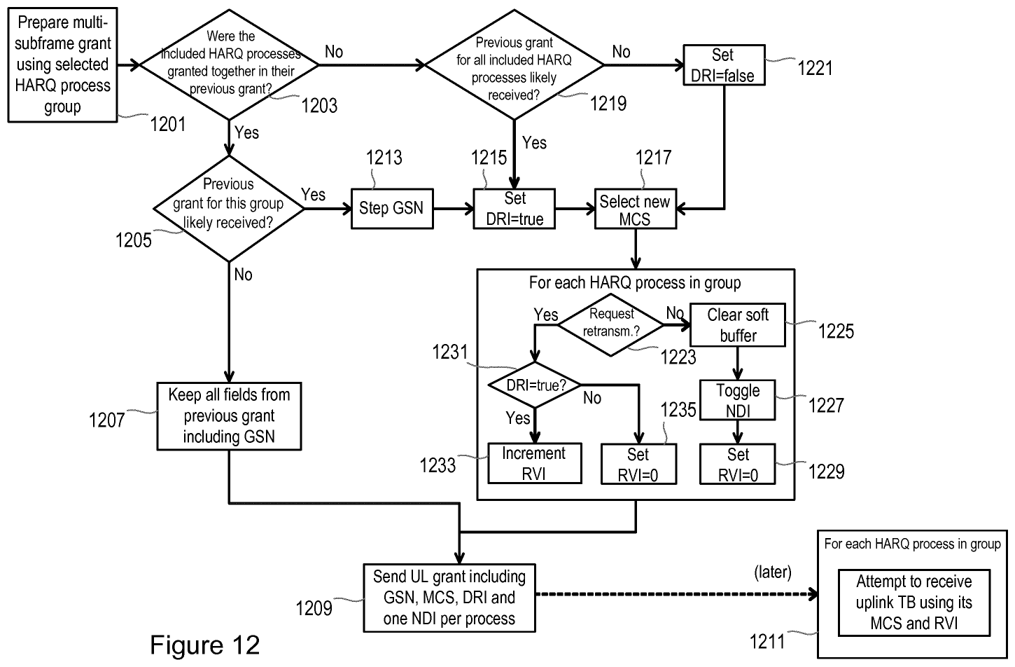

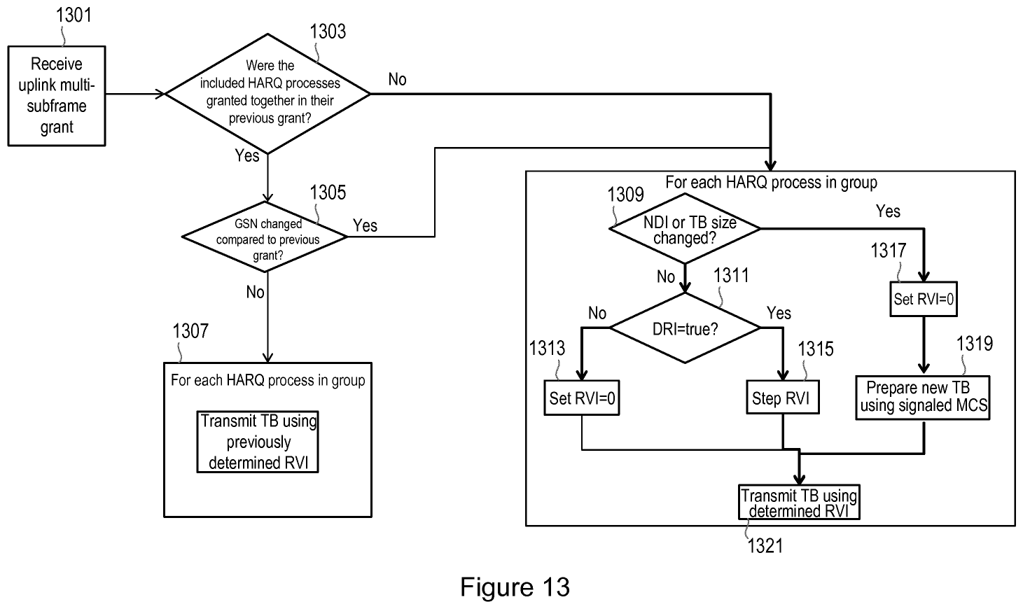

In some embodiments the UL grant message can contain one DRI field for each HARQ process indicated in the UL grant message. In this case the eNB 540 can set a DRI value for each HARQ process. In the embodiments that are shown in FIGS. 12 and 13, the UL grant message may grant multiple HARQ processes (i.e. the UL grant is a multi-subframe UL grant), but the UL grant only contains one DRI field. In this case, the value in the DRI field can be set based on a certain number of HARQ processes having a certain status.

Generally, if the eNB 540 (or other node in the communication network) determines that there is a risk of mismatch between the redundancy version to be used by the UE 542 and the redundancy version that the eNB 540 expects the UE 542 to use, the DRI can be used to instruct the UE 542 to reset the redundancy version to a known (i.e. predetermined) value, such as RV 0 or an explicitly signalled value. As used herein, the DRI will be set to ‘false’ in this situation (i.e. to indicate that the RV should be reset), and to ‘true’ if the RV should not be reset. Thus, if there is deemed to be risk of a mismatch, or the eNB determines that the redundancy version should be reset or set to a predetermined or particular value, the DRI value is used to indicate ‘False’ to the UE. The ‘False’ indicated value provides for the UE to acquire the RVI either implicitly (e.g. by setting it to a default value) or explicitly (for example if it is included in the UL grant message itself). If there is not deemed to be risk of a mismatch, or the UE managed process is considered acceptable, the DRI value is used to indicate ‘True’ to the UE so that the UE autonomously steps the RVI for the given HARQ process,

It will be appreciated that in some embodiments ‘true’ and ‘false’ can be used in the opposite manner. In some embodiments, the eNB 540 can determine whether there may be risk of a mismatch between the redundancy versions by determining whether the UE 542 has failed to receive the preceding UL grant message (for example according to the exemplary techniques described above for step 803).

The flow chart in FIG. 12 illustrates a method of operating an eNB 540 according to a third exemplary embodiment of the techniques described herein in which the UE-managed RV method is modified to include the use of a GSN and DRI as described above. In this method, each UL grant schedules multiple subframes.

In step 1201, the eNB 540 prepares an uplink grant message for a specific group of HARQ processes. The uplink grant message will indicate multiple subframes that the UE 542 is to use to transmit uplink data and a group of HARQ processes the UE 542 is to use.

In step 1203, the eNB determines if the HARQ processes in the group of HARQ processes were granted together in their previous UL grant message. Thus, the eNB determines whether that group of HARQ processes was treated as a group in a previous UL grant message. In other words, for each HARQ process included in the group of HARQ processes in the UL grant, the eNB 540 determines whether the most recent (previous) UL grant for that HARQ process included all of the other HARQ processes in the group in the current UL grant.

If the HARQ processes in the group of HARQ processes were granted together in their previous UL grant message, the method passes to step 1205 in which it is determined whether the UE 542 may have failed to receive the previous UL grant message relating to this group of HARQ processes (or, put another way, was the previous UL grant message for this group of HARQ processes likely to have been received by the UE). Step 1205 can be implemented using similar techniques to those described above for step 803.

If it is determined in step 1205 that the UE 542 may not have received the previous UL grant message for the group of HARQ processes, then the eNB keeps all of the field values from the previous (missed) UL grant, i.e. the GSN, NDI and DRI value (step 1207) and then sends an uplink grant message to the UE 542 (step 1209) using those kept field values. This uplink grant message is effectively a retransmission of the UL grant message for the group of HARQ processes that the UE 542 failed to receive. It will be appreciated that this uplink grant message may use the same MCS or a different MCS to the missed UL grant.

After sending the UL grant message in step 1209 the eNB 540 attempts to receive an uplink TB using the MCS and RVI specified in the UL grant message for each HARQ process in the group (step 1211).

If at step 1205 it is determined that the UE 542 has received the previous UL grant for the group of HARQ processes (i.e. DTX is not detected), then the method passes to step 1213 in which the eNB 540 steps or increments the GSN to the next GSN value, step 1215 in which the DRI is set to ‘True’ (to indicate that the RV should not be reset) and step 1217 in which the eNB selects a new MCS to use.

Returning to step 1203, if it is determined that the HARQ processes in the group of HARQ processes were not all granted together in their previous UL grant message, the method passes to step 1219 in which the eNB 540 determines whether the UE likely received the previous grant for all included HARQ processes. Step 1219 can be implemented using similar techniques to step 1205.

If it is determined in step 1219 that the UE 542 was likely to have received the previous UL grant for all included HARQ processes, then the method passes to step 1215 where the DRI is set to ‘True’, and then a new MCS is selected (step 1217). Thus in this situation step 1213 is not performed which means that the GSN is not increased. In fact, in this situation the value of GSN is irrelevant since the HARQ process groups have changed. Alternatively it could be the case that a new group of HARQ processes is arranged and the GSN is set to an initial value.

If it is determined in step 1219 that the UE 542 was not likely to have received the previous UL grant for all included HARQ processes, then the method passes to step 1221 where the DRI is set to ‘False’, and then a new MCS is selected (step 1217). Again, in this situation the value of GSN is irrelevant since the HARQ process groups have changed. Alternatively it could be the case that a new group of HARQ processes is arranged and the GSN is set to an initial value.

Following the selection of a new MCS in step 1217, then, for each HARQ process in the group, the eNB 540 determines whether the eNB 540 needs to request retransmission of the last data packet received from the UE 542 (step 1223). Retransmission will be required if the eNB 540 was not able to successfully receive and decode the previous data packet from the UE 542. If no retransmission is required, then the method moves to step 1225 in which the eNB 540 clears a soft buffer (the buffer that is used to store received data packets and their retransmissions so that they can be soft combined and correctly decoded). In some embodiment this soft buffer can be implemented in memory unit 766.

The eNB 540 then toggles (i.e. changes) the New Data Indicator field compared to the NDI field in the previous UL grant message for that HARQ process to indicate that the UL grant is for the transmission of new data from the UE (step 1227). The eNB 540 then sets a redundancy version indicator (RVI) field to 0 or some other default or initial value (step 1229),

If at step 1223 it is determined that the eNB does need to request retransmission, the method moves to step 1231 in which the DRI value is examined. If the DRI value is True, then the RVI is incremented (step 1233), as in step 819 of FIG. 8. If the DRI value is False, then the RVI is set to 0 or some other default or initial value (step 1235).

After step 1229, step 1233 or step 1235, the eNB sends the UL grant including the GSN, MCS, DRI value and one NDI per HARQ process (step 1209).

The flow chart in FIG. 13 illustrates a method of operating a UE 542 according to a third exemplary embodiment of the techniques described herein in which the UE-managed RV method is modified to include the use of a GSN and DRI as described above. In this method, each UL grant schedules multiple subframes.

In step 1301, the UE 542 receives an uplink grant message for a group of HARQ processes. The uplink grant message will indicate a plurality of subframes in which the UE 542 is to transmit uplink data (either explicitly or implicitly indicating this as noted above), along with NDI bits, the MCS the UE is to use and a value for the grant sequence number (GSN).

In step 1303, the UE 542 determines whether the group of HARQ processes specified in the received UL grant was treated as a group in a previous UL grant message. In other words, for each HARQ process included in the group of HARQ processes in the UL grant received in step 1301, the UE 542 determines whether the most recent (previous) UL grant for that HARQ process included all of the other HARQ processes in the group in the current UL grant.

If the HARQ processes were included together in their previous UL grant, then the UE 542 compares the GSN in the current UL grant (received in step 1301) and the previous UL grant (for that same group of HARQ processes) in step 1305.

If at step 1305 it is determined that the value of the GSN has not changed (i.e. the values of the GSNs in the two UL grants are the same), then the UL grant received in step 1301 is considered to be a repeated UL grant, and the method moves to step 1307 in which the UE 542, for each HARQ process in the group, retransmits the last transport block (TB)/data packet to the eNB 540 using the same RV that was used for the previous transmission of the data packet

If in step 1305 it is determined that the values of the GSNs in the UL grant messages are different, or in step 1303 it is determined that the HARQ processes in the received UL grant were not granted together in their previous grant, then the method passes to step 1309 in which the UE 542, for each HARQ process in the group, determines if the NDI field or a transport block (TB) size has changed compared to the last uplink grant message received from the eNB 540. The values of the GSNs will be different when either the UE 542 has missed an UL grant message and the eNB 540 resends it according to steps 1205, 1207 and 1209 in FIG. 12, or the eNB 540 considers that the UE did receive the previous UL grant and sends a new UL grant to the UE 542.

In step 1309, if neither of the NDI field and TB size have changed then the eNB 540 is requesting retransmission of the previous data packet according to the HARQ process, and the UE 540 determines if the DRI value in the received UL grant is set to True (step 1311). If the DRI is not set to True, then the UE 542 sets the RVI to 0 or some other default value (step 1313). If the DRI value is set to True, then the UE steps the RVI to the next RV in step 1315.

If either or both of the NDI field and TB size have changed then the eNB 540 is requesting the transmission of new data from the UE, and the UE 542 sets a redundancy version indicator (RVI) field to 0 or some other default or initial value (step 1317). The UE 542 then prepares a data packet/TB with new data using the MCS signalled in the UL grant message received in step 1301 (step 1319).

After step 1313, 1315 or 1319 the method passes to step 1321 in which the UE 542 transmits the data packet/TB with the required data to the eNB using the RVI determined in step 1313, 1315 or 1319 (as appropriate).

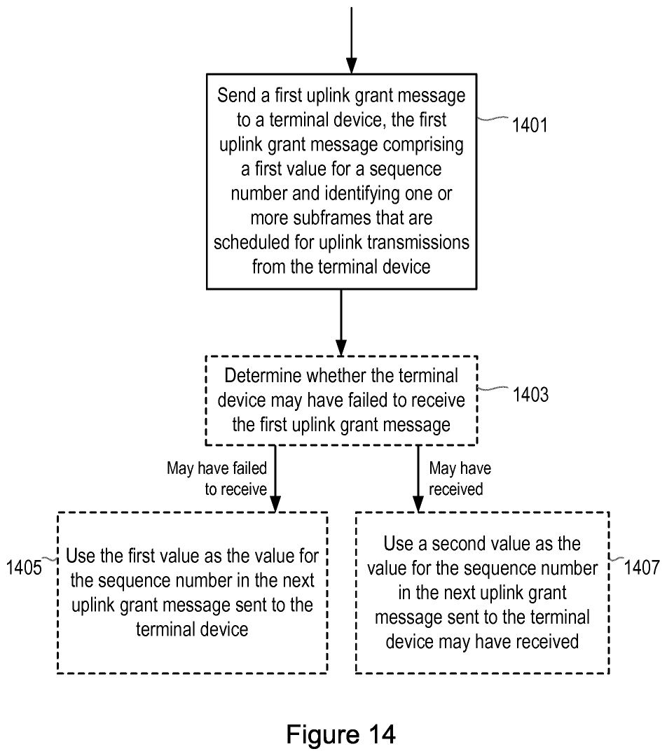

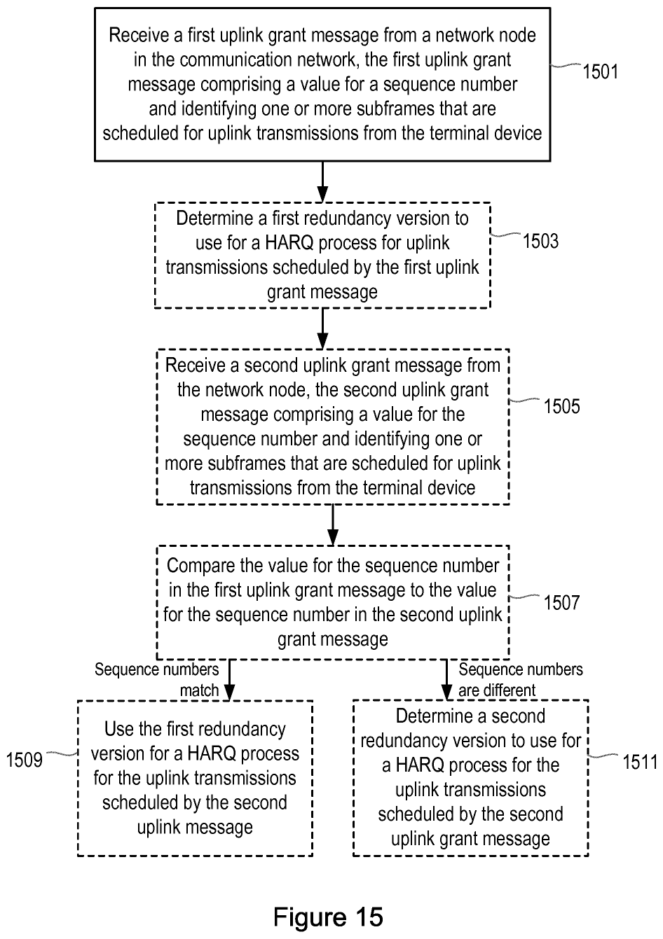

The flow charts in FIGS. 14 and 15 illustrate general methods of operating a network node (e.g. an eNB) and a terminal device (e.g. a UE) respectively in accordance with the techniques described herein.

Thus, in step 1401 in FIG. 14, a network node sends a first uplink grant message to a terminal device. This first uplink grant message comprises a first value for a sequence number (e.g. a grant sequence number (GSN) and comprises information for one or more subframes that are scheduled for uplink transmissions from the terminal device. In some embodiments the value for the sequence number is represented by one or more bits in a field in an uplink grant message.

In some embodiments, the first value can be the same value as a value for the sequence number that was comprised in a previous uplink grant message sent to the terminal device if the terminal device may have failed to receive said previous uplink grant message. The first value can be a different value to the value for the sequence number that was comprised in the previous uplink grant message sent to the terminal device if the terminal device may have received said previous uplink grant message.

In some embodiments, the first uplink grant message further comprises an indication of one or more hybrid automatic repeat request, HARQ, processes that the first uplink grant message relates to, and wherein the previous uplink grant message is the last uplink grant message sent to the terminal device that relates to said one or more HARQ processes. In some embodiments, the one or more HARQ processes indicated in the first uplink grant message are considered as a group of HARQ processes, and the previous uplink grant message is the last uplink grant message sent to the terminal device that indicates the same group of HARQ processes.

In some embodiments (indicated by the dashed outlines in FIG. 14), after step 1401 the network node determines whether the terminal device may have failed to receive the first uplink grant message (step 1403). Step 1403 can be performed using any of the techniques described above for step 803 or step 1009.

If it is determined in step 1403 that the terminal device may have failed to receive the first uplink grant message, then the network node uses the first value as the value for the sequence number in the next uplink grant message that is sent to the terminal device.

However, if it is determined in step 1403 that the terminal device may have received the first uplink grant message, then the network node uses a second value as the value for the sequence number in the next uplink grant message that is sent to the terminal device. The second value may be the next value in a sequence after the first value for the sequence number.

In further embodiments, the first uplink grant message further comprises an indication of whether the terminal device should manage the RV itself or reset the RV to a known (i.e. predetermined) or signalled value. This indication is referred to herein as the DRI.

In some embodiments, the network node uses the indication to indicate that the RV should be reset to a known or signalled value if the terminal device may have failed to receive a previous uplink grant message, and uses the indication to indicate that the terminal device should manage the RV if the terminal device may have received a previous uplink grant message.

In some embodiments, each uplink grant message can comprise an indication of a group of uplink grant messages to which that uplink grant message belongs. The indication can be represented by one or more bits in a field in an uplink grant message. The network node can determine the group of uplink grant messages to which that uplink grant message belongs, e.g. based on a set of HARQ processes identified in the uplink grant message. In some embodiments, each set of HARQ processes is associated with a respective group of uplink grant messages.

In some embodiments, the network node can indicate a different group in the next uplink grant message to the group indicated in the first uplink grant message if the set of HARQ processes identified in the next uplink grant message is different to the set of HARQ processes identified in the first uplink grant message. The network node can indicate the same group in the next uplink grant message as the group indicated in the first uplink grant message if the set of HARQ processes identified in the next uplink grant message is the same as the set of HARQ processes identified in the first uplink grant message.

Referring now to FIG. 15, in step 1501 the terminal device receives a first uplink grant message from a network node in the communication network. The first uplink grant message comprises a value for a sequence number and comprises information for one or more subframes that are scheduled for uplink transmissions from the terminal device. In some embodiments, the value for the sequence number can be represented by one or more bits in a field in an uplink grant message.

In some embodiments (indicated by the dashed outlines in FIG. 15), the terminal device determines a first redundancy version to use for a HARQ process for uplink transmissions scheduled by the first uplink grant message (step 1503). Although not shown in FIG. 15, the terminal device transmits one or more data packets/transport blocks to the network node according to the subframe(s) scheduled in the first uplink grant message.

In some embodiments, in step 1505 the terminal device receives a second uplink grant message from the network node. The second uplink grant message comprises a value for the sequence number and comprises information for one or more subframes that are scheduled for uplink transmissions from the terminal device.

In some embodiments the terminal device compares the value for the sequence number in the first uplink grant message to the value for the sequence number in the second uplink grant message (step 1507).

In some embodiments the first and second uplink grant messages further comprise a respective indication of one or more HARQ processes that the first and second uplink grant message relate to. Therefore, in some embodiments, the step of comparing sequence numbers is only performed if the first and second uplink grant messages relate to the same one or more HARQ processes.

If it is determined in step 1507 that the value for the sequence number in the first uplink grant message is the same as the value for the sequence number in the second uplink grant message then the terminal device uses the first redundancy version for a HARQ process for the uplink transmissions scheduled by the second uplink message.

However, if it is determined in step 1507 that the value for the sequence number in the first uplink grant message is different to the value for the sequence number in the second uplink grant message, then the terminal device determines a second redundancy version to use for a HARQ process for uplink transmissions scheduled by the second uplink grant message.

In some embodiments, the terminal device can determine the second redundancy version as an initial value for the redundancy version if the second uplink grant message relates to a new uplink transmission or a transport block size has changed. If the second uplink grant message does not relate to a new uplink transmission and the transport block size has not changed, then the next redundancy version in a sequence after the first redundancy version can be used as the second redundancy version.

In some embodiments, the first uplink grant message further comprises an indication of whether the network node considers that there may be a mismatch between a redundancy version for a HARQ process that is to be used by the terminal device and the redundancy version that the network node expects the terminal device to use for a HARQ process. This indication is the DRI described above. The terminal device uses the indication of whether there is a mismatch in determining the redundancy version to use for a HARQ process, for example as shown in FIG. 13.

In some embodiments, each of the uplink grant messages can further comprise an indication of a group of uplink grant messages to which that uplink grant message belongs. In these embodiments step 1507 may only be performed if the first uplink grant message belongs to the same group as the second uplink grant message. In some embodiments the indication is represented in a field (e.g. by one or more bits) in an uplink grant message.

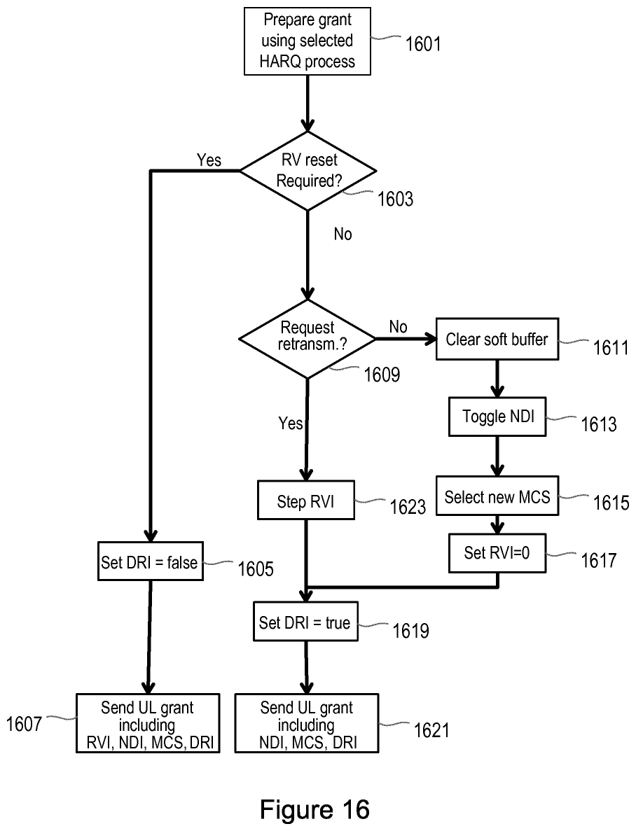

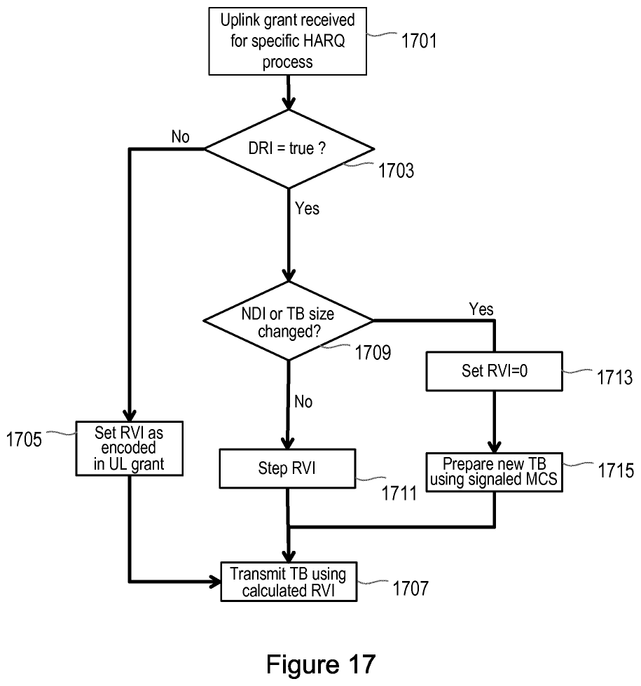

Some further embodiments of the techniques described herein are illustrated in FIGS. 16 and 17. The embodiments in FIGS. 16 and 17 relate to the use of the DRI described above, but without the use or presence of a sequence number (GSN) or GSN group indication.

Thus, in these embodiments, in order to ensure that a UE and an eNB have a common understanding of the RV to be used for a given HARQ process, the eNB includes the Differential RVI Indicator (DRI) in an uplink grant message that is used by the eNB to indicate whether the UE is to autonomously step the RVI for the given HARQ process, set or reset the RVI. The UE may acquire the RVI either implicitly (e.g. by setting it to a default value) or explicitly (for example if it is included in the UL grant message itself).

Thus, in some embodiments the UL grant message structure is modified to include a DRI. The DRI can be represented by one or more bits in respective fields in the UL grant. In some examples, the DRI is represented by a single bit. Thus, the DRI is explicitly signalled in an UL grant message, for example using one or more bits in a field in the UL grant message. Alternatively, the DRI can be signalled together with other pieces of information. As another alternative, the DRI can be explicitly signalled to indicate one of the statuses (i.e. one of: the UE is to autonomously step the RVI, or acquire the RVI either implicitly or explicitly) and omitted to indicate the other status.

In some embodiments the UL grant message can contain one DRI field for each HARQ process indicated in the UL grant message. In this case the eNB 540 can set a DRI value for each HARQ process. In the embodiments that are shown in FIGS. 16 and 17, the UL grant message may grant multiple HARQ processes (i.e. the UL grant is a multi-subframe UL grant), but the UL grant only contains one DRI field. In this case, the value in the DRI field can be set based on a certain number of HARQ processes having a certain status.

Generally, if the eNB 540 (or other node in the communication network) determines that there may be a mismatch between the redundancy version to be used by the UE 542 and the redundancy version that the eNB 540 expects the UE 542 to use, the DRI can be used to indicate this to the UE 542. As used herein, the DRI is set to ‘false’ in this situation to reset the RVI to a known value, and to ‘true’ if the UE can resume the UE managed RVI method. Thus, if the eNB considers there is a risk of a mismatch, the DRI value is used to indicate ‘False’ to the UE so that the UE acquires the RVI either implicitly (e.g. by setting it to a default value) or explicitly (for example if it is included in the UL grant message itself). If there is not deemed to be a risk of a mismatch, the DRI value is used to indicate ‘True’ to the UE so that the UE autonomously steps the RVI for the given HARQ process,

It will be appreciated that in some embodiments ‘true’ and ‘false’ can be used in the opposite manner. In some embodiments, the eNB 540 can determine whether there may be a mismatch between the redundancy versions by determining whether the UE 542 has failed to receive the preceding UL grant message (for example according to the exemplary techniques described above for step 803).

In some other embodiments, the eNB 540 can determine whether there is a risk of a mismatch between the redundancy versions by determining whether the set of HARQ process IDs granted in an UL grant message have changed between subframes and there is partial overlap between the sets as compared to the HARQ process IDs granted in the previous UL grant message. If the set of HARQ processes have changed and there is partial overlap then the DRI can be used to request the RVI(s) to be reset (e.g. the DRI is set to false).

The network/eNB 540 can keep track of the RV version to be used for each HARQ process. In some cases the eNB 540 will determine the risk of RV mismatch between the network and the UE being large for some of the HARQ processes. If so, in embodiments where the UL grant contains one DRI field for each indicated HARQ process, the eNB 540 will set the DRI to false for each said HARQ process being deemed to have a high risk of mismatch. For those determined to have a good match of RV between the eNB 540 and UE 542, then the DRI will be set to true. In the embodiments in which the UL grant contains only one DRI field but more than one HARQ process is granted in the UL grant, then the eNB 540 can set the DRI to false if any one or at least a threshold number of the granted HARQ processes is deemed to have a high risk of mismatch.

As noted above, when the DRI is set to false the NW/eNB will, in some related embodiments, explicitly encode in the UL grant which RVI the UE shall use. This encoding may be done either using a single RV field that applies to all granted HARQ processes, or a separate field for each granted HARQ process. The encoding could preferably be done using the existing RV field in the UL grant. The explicit RVI value set by the eNB may, for example, correspond to the next RVI expected by the eNB with respect to what it has received previously and stored in the soft-buffer of the eNB for the given HARQ process. In some other embodiments, the RVI is instead determined a priori to take on a specific value, e.g. zero, without the need for explicit signalling thereof. This value could, e.g., be hard-coded in the specifications, configured via RRC-signalling beforehand, etc.

In some embodiments, instead of encoding the DRI and RV fields separately, the DRI can be jointly encoded with the RV. As an example, in the case of the field being two bits long, this could be jointly encoded as:
00: (DRI=false & RV=0)
01: (DRI=false & RV=1)
10: (DRI=false & RV=2)
11: (DRI=true)

If, on the other hand, the eNB estimates that the UE did receive the previous UL grant successfully (i.e., DTX was not detected), then the DRI shall be set to true. This will instruct the UE to increment the RVI used for the transmission of the given HARQ process as further described below. In some embodiments, the RVI is incremented by one. In some other embodiments, the incremental step is explicitly encoded in the UL grant (e.g., in the RV field).

The flow chart in FIG. 15 illustrates a method of operating an eNB 540 according to an exemplary embodiment of the techniques described herein in which the UE-managed RV method is modified to include the use of a DRI as described above. In this method, each UL grant schedules multiple subframes.

In step 1601, the eNB 540 prepares an uplink grant message for a specific HARQ process (or group of HARQ processes). The uplink grant message will comprise information for one subframe or multiple subframes (in the case of multi-subframe scheduling) that the UE 542 is to use to transmit uplink data. In some cases this information will be explicit, i.e. the information will explicitly identify one subframe or multiple subframes, whereas in other cases the timing of the uplink grant message will indicate the subframe(s).

In step 1603 the eNB determines whether there may be a mismatch between the RV that the UE is going to use and the RV the eNB expects the UE to use. Step 1603 can be performed as described above.

If a mismatch is detected in step 1603, the eNB sets the DRI to false (step 1605) and sends the uplink grant message including an NDI field, an MCS, the correct RVI and the DRI value (step 1607).

If no mismatch is detected in step 1603, the eNB determines whether the eNB 540 needs to request retransmission of the last data packet received from the UE 542 (step 1609). Retransmission will be required if the eNB 540 was not able to successfully receive and decode the previous data packet from the UE 542. If no retransmission is required, then the method moves to step 1611 in which the eNB 540 clears a soft buffer (the buffer that is used to store received data packets and their retransmissions so that they can be soft combined and correctly decoded). In some embodiment this soft buffer can be implemented in memory unit 766.

The eNB 540 then toggles (i.e. changes) the New Data Indicator field compared to the NDI field in the previous UL grant message for that HARQ process to indicate that the UL grant is for the transmission of new data from the UE (step 1613). The eNB 540 then selects a new MCS for the UL grant (step 1615) and sets a redundancy version indicator (RVI) field to 0 or some other default or initial value (step 1617).

The eNB then sets the DRI to true (step 1619) and sends the uplink grant message including an NDI field, an MCS and the DRI value (step 1621). The MCS may be the same as indicated in the previous UL grant message or different.

If at step 1609 the eNB 540 requires a retransmission of the last data packet from the UE, the method passes to step 1623 in which the eNB 540 steps the RVI to the next RV. The eNB 540 then sets the DRI to true (step 1619). The eNB then sends the uplink grant message including an NDI field, an MCS and the DRI value (step 1621). No RVI is included in this UL grant as no reset of the RVI is required. The MCS may be the same as indicated in the previous UL grant message or different.

It will be appreciated that Steps 1609 onwards in FIG. 16 can be performed for each HARQ process in a group of HARQ processes identified in the UL grant. That is, for each HARQ process it is determined whether retransmission should be requested (step 1609), and the RVI is set to the correct value (step 1617 or 1623).

On the UE side, whenever the UE receives an UL grant with the DRI set to false it shall set the RVI to use for the re-transmissions of the considered HARQ processes to a RVI value explicitly indicated in the UL grant (e.g., in the RVI field), or to a predetermined RVI value (e.g., zero) which may be hard-coded in the specifications or previously assigned to the UE via RRC-signalling, etc.

If, on the other hand, the DRI is set to true, then the UE shall instead follow the UE managed RV method described above for the given HARQ process, i.e., step the RVI to the next value (in case of a retransmission) or reset the RVI to its initial value (in case of a new transmission) and thereafter perform the corresponding (re)transmission.

The flow chart in FIG. 17 illustrates a method of operating a UE 542 according to an exemplary embodiment of the techniques described herein in which the UE-managed RV method is modified to include the use of a DRI as described above. In this method, or in a method of any example, each UL grant schedules multiple subframes.

In step 1701, the UE 542 receives an uplink grant message for a specific HARQ process or group of HARQ processes. The uplink grant message will comprise information for one or more subframes in which the UE 542 is to transmit uplink data (either explicitly or implicitly as noted above), along with an NDI field, the MCS the UE is to use and a value for the DRI.

In step 1703, the UE determines whether the DRI value in the UL grant is set to true. If the DRI value is set to false, then the UE sets the RVI to an RVI encoded in the UL grant (e.g. encoded with the MCS) or to a default value (step 1705), and the UE 542 transmits a TB/data packet to the eNB 540 using the calculated RVI (step 1707).

If in step 1703 it is determined that the DRI value is set to true, the method passes to step 1709 in which the UE 542 determines if the NDI field or a transport block (TB) size has changed compared to the last uplink grant message received from the eNB 540.

In step 1709, if neither of the NDI field and TB size have changed then the eNB 540 is requesting retransmission of the previous data packet according to the HARQ process, and the UE 540 steps the RVI to the next RV in step 1711. The UE 542 then transmits the data packet/TB to the eNB 540 using the RVI determined in step 1711 (step 1707).

If either or both of the NDI field and TB size have changed then the eNB 540 is requesting the transmission of new data from the UE, and the UE 542 sets the RVI field to 0 or some other default or initial value (step 1713). The UE 542 then prepares a data packet/TB with new data using the MCS signalled in the UL grant message received in step 1701 (step 1715). The UE 542 then transmits the data packet/TB with the new data to the eNB using the RVI determined in step 1713 (step 1707).

Where the UL grant relates to a group of HARQ processes, the transmission of a data packet/TB in step 1707 is performed for each HARQ process in the group. Steps 1709-1715 are also performed for each HARQ process in the group.

In an alternative embodiment to that shown in FIG. 17, after receipt of the UL grant, the NDI bit is checked, and the DRI is checked if the NDI bit is not set. If the NDI bit is set, there is no need to check if DRI is true/false since the RVI will be set to 0 in step 1713.

Although in the embodiments described above that use a GSN and/or DRI, the values of the GSN and DRI are set based on the network determining whether the UE may have missed an UL grant, it will be appreciated that, in some embodiments, the GSN and/or DRI can be set based on other considerations (i.e. independently of whether the UE may have missed an UL grant). For example, it is possible that DRI can be set to false because RV=0 has better performance in some respects, or consumes less power, etc. As another (or further) example, the GSN could be used to resend a particular UL grant, or every nth UL grant.

There is therefore provided improvements to the UE-managed RV method to enable a network node (e.g. eNB) and a terminal device (e.g. a UE) to be in agreement on which (re)transmission attempt a particular UL grant schedules. This is achieved by providing a sequence number in the UL grant messages.

Modifications and other variants of the described embodiment(s) will come to mind to one skilled in the art having the benefit of the teachings presented in the foregoing descriptions and the associated drawings. Therefore, it is to be understood that the embodiment(s) is/are not to be limited to the specific examples disclosed and that modifications and other variants are intended to be included within the scope of this disclosure. Although specific terms may be employed herein, they are used in a generic and descriptive sense only and not for purposes of limitation. Any example may be used in combination with, or in isolation from, any other example or feature. For example, an aspect may use the described DRI without a sequence number, or a sequence number without the DRI. Alternatively, a method or apparatus may use both the sequence number (and optionally GSNG) and DRI.

Some exemplary statements for the DRI embodiments are set out below:

Statement 1. A method of operating a network node in a communication network, the method comprising sending an uplink grant message to the terminal device, the uplink grant message comprising information for one or more subframes that are scheduled for uplink transmissions and/or retransmissions from the terminal device and comprising a redundancy version, RV, status.

Statement 2. A method as defined in statement 1, wherein the RV status comprises an indication whether the terminal device is to set the RV to a predetermined value or the terminal device is to autonomously manage the selection of the RV for a given hybrid automatic repeat request, HARQ, process.

Statement 3. A method as defined in statement 2, wherein the communication network indicates whether the terminal device is to set the RV to a predetermined value based on the communication network determining that there may be a risk of a mismatch.

Statement 4. A method as defined in statement 3, wherein determining the risk of a mismatch comprises:

determining whether the terminal device may have failed to receive an uplink grant message sent to the terminal device.

Statement 5. A method as defined in any of statements 1-4, wherein, in the event that the uplink grant message comprises information for two or more subframes that are scheduled for uplink transmissions, the RV status applies to any one or more of the two or more subframes.

Statement 6. A method as defined in any of statements 1-5, wherein the step of sending an uplink grant message further comprises indicating a redundancy version for the terminal device to use in a hybrid automatic repeat request, HARQ, process in the uplink grant message based on the RV status.

Statement 7. A method as defined in statement 6, wherein the indication of the redundancy version for the terminal device to use is encoded in the uplink grant message together with the RV status.

Statement 8. A network node for use in a communication network, the network node being adapted to:
send an uplink grant message to the terminal device, the uplink grant message comprising information for one or more subframes that are scheduled for uplink transmissions and/or retransmissions from the terminal device and comprising a redundancy version, RV, status.

Statement 9. A method of operating a terminal device in a communication network, the method comprising:
receiving a first uplink grant message from a network node in the communication network, the first uplink grant message comprising information for one or more subframes that are scheduled for uplink transmissions and/or re-transmissions from the terminal device and comprising a redundancy version, RV, status. In some examples, the RV status is an indication of whether the terminal device is, for re-transmissions, to set the RV to a predetermined value and/or the terminal device is to autonomously manage the selection of the RV.

Statement 10. A method as defined in statement 9, the method further comprising the step of determining a redundancy version to use for a hybrid automatic repeat request, HARQ, process for the uplink transmissions scheduled by the first uplink grant message based on the RV status indication.

Statement 11. A method as defined in statement 10, wherein the step of determining comprises:
using a redundancy version signalled in the first uplink grant message if the indication in the first uplink grant message indicates that terminal device is to set the RV to a predetermined value.

Statement 12. A method as defined in statement 10, wherein the step of determining comprises:
using a default redundancy version if the indication in the first uplink grant message indicates that terminal device is to set the RV to a predetermined value.

Statement 13. A method as defined in statement 12, wherein the default redundancy version is signalled to the terminal device in Radio Resource Control signalling.

Statement 14. A method as defined in any of statements 9-13, wherein the indication in the first uplink grant message is encoded together with a redundancy version that the terminal device is to use in the hybrid automatic repeat request, HARQ, process.

Statement 15. A terminal device for use in a communication network, the terminal device being adapted to:
receive a first uplink grant message from a network node in the communication network, the first uplink grant message identifying one or more subframes that are scheduled for uplink transmissions and/or re-transmissions from the terminal device and comprising a redundancy version, RV, status indication of whether the terminal device is, for re-transmissions, to set the RV to a predetermined value or the terminal device is to autonomously manage the selection of the RV.

1.-26. (canceled)

27. A method of operating a network node in a communication network, the method comprising:
setting a redundancy version indicator, RVI, to a value from a predefined sequence of values, wherein the redundancy version indicator is stepped when a retransmission is scheduled and wherein a corresponding RVI of a terminal device is stepped by the terminal device when a corresponding retransmission is performed;
sending an uplink grant message to a terminal device, the uplink grant message comprising a value for a sequence number and the grant message comprising information for one or more subframes that are scheduled for uplink transmissions from the terminal device, wherein, when the uplink grant message is a repeat of a previous uplink grant message, the sequence number is sent with the same value as for the previous uplink grant message, and when the uplink grant message is for scheduling a retransmission of an uplink transmission corresponding to a previous uplink grant message, the sequence number to be sent is stepped and the RVI is stepped to the next value in the predefined sequence of values.

28. A method as claimed in claim 27, wherein the method further comprises the step of determining whether the terminal device has failed to receive the previous uplink grant message wherein the uplink grant message is a repeat of the previous uplink grant message when it is determined that the terminal device has failed to receive the previous uplink grant message; and wherein the uplink grant message is for scheduling a retransmission of an uplink transmission when the network node requires a retransmission of a previous data packet from the terminal device.

29. A method as claimed in claim 27, wherein the uplink grant message further comprises an indication that identifies a group of uplink grant messages that the uplink grant message belongs to.

30. A method as claimed in claim 27, wherein the uplink grant message further comprises an indication of one or more hybrid automatic repeat request, HARQ, processes that the uplink grant message relates to, and/or wherein the previous uplink grant message was the last uplink grant message sent to the terminal device that relates to said one or more HARQ processes.

31. A method as claimed in claim 27, wherein the uplink grant message comprises information for a plurality of subframes that are scheduled for uplink transmissions from the terminal device, and/or wherein the value for the sequence number is represented by one or more bits in a field in the uplink grant message.

32. A method as claimed claim 27, wherein the uplink grant message further comprises an indication of whether the terminal device should reset the RVI to a known or signalled value, or manage the RVI itself;
and/or wherein the network node determines the indication in an uplink grant comprising a group of hybrid automatic repeat request, HARQ, processes, to request the terminal device to reset or set the redundancy version, RV, to a predetermined or signalled value when the network node deems the terminal device to have failed to receive a previous uplink grant message, or determines the indication to indicate that the terminal device should manage the RV when the network node deems the previous uplink grant message or messages were received by the terminal device.

33. A network node for use in a communication network, the network node being adapted to:
set a redundancy version indicator, RVI, to a value from a predefined sequence of values, wherein the RVI is stepped when a retransmission is scheduled and wherein a corresponding RVI is stepped by a terminal device when a corresponding retransmission is performed;
send an uplink grant message to a terminal device, the uplink grant message comprising a first value for a sequence number and the uplink grant comprising information for one or more subframes that are scheduled for uplink transmissions from the terminal device, wherein, when the uplink grant message is a repeat of a previous uplink grant message, the sequence number is sent with the same value as for the previous uplink grant message, and when the uplink grant message is for scheduling a retransmission of an uplink transmission corresponding to a previous uplink grant message, the sequence number to be sent is stepped and the RVI is stepped to the next value in the predefined sequence of values.

34. A network node as claimed in claim 33, wherein the network node is further adapted to determine whether the terminal device has failed to receive the previous uplink grant message wherein the uplink grant message is a repeat of the previous uplink grant message when it is determined that the terminal device has failed to receive the previous uplink grant message; and wherein the uplink grant message is for scheduling a retransmission of an uplink transmission when the network node requires a retransmission of a previous data packet from the terminal device, and/or wherein the first uplink grant message further comprises an indication of whether of whether the terminal device should reset a redundancy version, RVI, to a predetermined or signalled value, or manage the RVI itself.

35. A method of operating a terminal device in a communication network, the method comprising:
receiving an uplink grant message from a network node in the communication network, the uplink grant message comprising a value for a sequence number and comprising information for one or more subframes that are scheduled for uplink transmissions from the terminal device;
comparing the value of the sequence number with a value of a sequence number received in an earlier uplink grant message, and
determining a redundancy version indicator, RVI, value of a HARQ process based on the comparison.

36. A method as claimed in claim 35, wherein the uplink grant message is a second uplink grant message and the earlier uplink grant message is a first uplink grant message, and determining the RVI value to use for the, HARQ, process for uplink transmissions scheduled by the second uplink grant message comprises:
using the RVI value for a HARQ process for the uplink transmissions scheduled by the first uplink grant message when the value for the sequence number in the second uplink grant message is the same as the value for the sequence number in the first uplink grant message; and
determining a second redundancy version to use for a HARQ process for uplink transmissions scheduled by the second uplink grant message when the value for the sequence number in the second uplink grant message is different to the value for the sequence number in the first uplink grant message.

37. A method as claimed in claim 36, wherein the first and second uplink grant messages further comprise a respective indication of one or more HARQ processes that the first and second uplink grant message relates to, and wherein the step of comparing is performed if the first and second uplink grant messages relate to the same one or more HARQ processes and or wherein the step of determining a second redundancy version to use for a HARQ process for uplink transmissions scheduled by the second uplink grant message comprises:
determining the second RVI value as an initial value if the second uplink grant message relates to a new uplink transmission or a transport block size has changed; and
otherwise, determining the second RVI value as the next RVI value in a predefined sequence of values.

38. A method as claimed in claim 35, wherein the uplink grant message further comprises an indication of whether the terminal device should reset or set the RVI, to a predetermined or signalled value, or manage the RVI itself and/or wherein the method further comprises the step of:
determining the RVI to use for a hybrid automatic repeat request, HARQ, process based on the indication of whether the terminal device should reset or set the RVI to a predetermined or signalled value, or manage the RVI itself.

39. A terminal device for use in a communication network, the terminal device being adapted to:
receive an uplink grant message from a network node in the communication network, the uplink grant message comprising a value for a sequence number and comprising information for one or more subframes that are scheduled for uplink transmissions from the terminal device;
compare the value for the sequence number in the uplink grant message to a value for a sequence number in an earlier uplink grant message; and
determine a redundancy version indicator, RVI, value to use for a hybrid automatic repeat request, HARQ, process for uplink transmissions scheduled by the uplink grant message based on the comparison.

40. A terminal device as claimed in claim 39 wherein the received uplink grant message is a second uplink grant message from the network node, and the earlier uplink grant message is a first uplink grant message and the RVI for the HARQ process is determined as the same as a RVI value used for a HARQ process for the uplink transmissions scheduled by the first uplink message when the value for the sequence number in the second uplink grant message is the same as the value for the sequence number in the first uplink grant message; and the RVI value is
determined as a second RVI to use for a HARQ process for uplink transmissions scheduled by the second uplink grant message when the value for the sequence number in the second uplink grant message is different to the value for the sequence number in the first uplink grant message.

41. A computer program product comprising a computer readable medium having computer readable code embodied therein, the computer readable code being configured such that, on execution by a suitable computer or processor, the computer or processor is caused to perform the method of claim 27.
